(19) United States
(12) Patent Application Publication
(10) Pub. No.: US 2026/0075491 A1
(43) Pub. Date: Mar. 12, 2026

(54) FAILURE HANDLING IN LOWER LAYER MOBILITY USING CONDITION

(71) Applicant: Nokia Technologies Oy, Espoo (FI)

(72) Inventors: Panagiotis SPAPIS, Munich (DE); Halit Murat GÜRSU, Munich (DE); Umur KARABULUT, Munich (DE); Ahmad AWADA, Munich (DE); Amaanat ALI, Espoo (FI); Srinivasan SELVAGANAPATHY, Bangalore (IN); Subramanya CHANDRASHEKAR, Bangalore (IN); Jedrzej STANCZAK, Wroclaw (PL)

(21) Appl. No.: 19/101,105

(22) PCT Filed: Jun. 14, 2023
(86) PCT No.: PCT/EP2023/065945

§ 371 Date: Feb. 4, 2025

(30) Foreign Application Priority Data
Aug. 4, 2022 (IN) 202241044595

(51) Int. Cl. H04W 36/30; H04W 36/00; H04W 36/36

(52) U.S. Cl. CPC H04W 36/305; H04W 36/0058; H04W 36/362

(57) ABSTRACT

Inter alia apparatuses for lower layer mobility are disclosed. Further an apparatus is disclosed comprising, at least one processor; and at least one memory storing instructions that, when executed by the at least one processor, cause the apparatus at least to perform:—Receiving a conditional configuration and a conditional configuration information; and—At least one of the following: determining a handover based on a layer 3 measurement of at least one candidate cell or a layer 1 measurement; or determining to wait for a network command for a handover based on the conditional configuration information. It is further disclosed according methods, computer programs and systems.

### FIELD

The following disclosure relates to the field of wireless networks, or more particularly relates to systems, apparatuses, and methods for lower layer mobility.

### BACKGROUND

Lower Layer Mobility (LLM), marked also as L1/2 inter-cell mobility, may be one of the upcoming objectives for mobility enhancement. Cell handover in LLM may be problematic, in particular if a L1 report message, or the MAC CE message to trigger cell change are lost, a UE may experience RLF as the cell change cannot be triggered at the UE. Then the UE may have to perform cell reselection in order to identify the proper cell to connect to.

### SUMMARY OF SOME EXEMPLARY EMBODIMENTS

For convenience, a list of abbreviations used in the following is already given at this point:
CHO Conditional Handover
CP Control Plane
CU Central Unit
DL Downlink
gNB Basestation in NR
HO Handover
HOF Handover Failure
L1 layer 1 (in particular physical layer)
L2 layer 2 (in particular MAC layer)
L3 layer 3 (in particular RRC layer)
MAC Media Access Control
MAC CE MAC Control Element
NR New Radio
OAM Operations, Administration and Maintenance
RACH Random Access Channel
RLF Radio Link Failure
RRC Radio Resource Control
UE User Equipment
UP User Plane

Exemplary aspects and exemplary embodiments provided below may enable enhanced signalling, efficient resource reservation and interworking, enhanced handover procedure, e.g. faster and more efficient handover between cells, reduced interruption time in case of failure of LLM, reducing the probability of an RLF maintaining control in the network in case a UE is configured with LLM and CHO, or LLM with condition. For instance a combination of an RRC configuration of CHO with that of LLM may allow for efficient resource reservation and interworking. Further an LLM RRC configuration may be enhanced. LLM may enable reduced interruption time during handover execution. Additionally the network may be enabled to maintain control of a handover in case of fast network degradation. Exemplary aspects and exemplary embodiments provided below may further enable to achieve the same or similar robustness for LLM as for CHO.

According to a first exemplary aspect, an apparatus (e.g. a mobile entity or UE) is disclosed, the apparatus comprising at least one processor; and at least one memory storing instructions that, when executed by the at least one processor, cause the apparatus at least to perform:
Receiving (e.g. from a second apparatus) a conditional configuration and a conditional configuration information (e.g. for a candidate cell provided by a candidate network node); and
At least one of the following: determining a handover (e.g. between a source cell provided by the second apparatus and the candidate cell) based on a layer 3 measurement of at least one candidate cell or a layer 1 measurement; or determining to wait for a network command for a handover based on the conditional configuration information.

The conditional configuration and a conditional configuration information may e.g. be comprised by at least on configuration. The conditional configuration may e.g. be or comprise a dual configuration, a common configuration, a lower layer mobility configuration comprising a lower layer mobility condition, or a lower layer mobility configuration and a conditional handover configuration. The conditional configuration information may e.g. be or comprise a handover condition and/or at least one or at least two timer.

Determining a handover may e.g. comprise evaluating (or determining) a handover condition, and based on evaluating (or determining) that the handover condition is present, initiating a handover to a target cell of at least one candidate cell, and optionally determining a handover completion condition (e.g. based on determining a handover completion condition is not present, e.g. the handover is not successful, initializing cell recovery. A network command for a handover may e.g. be or comprise a handover trigger or a stay trigger. determining to wait for a network command for a handover based on the conditional configuration information, may be e.g. determining to wait for a network command, in case the conditional configuration information comprises an instruction to wait for a network command.

The apparatus may be an apparatus for lower layer mobility, e.g. an apparatus having means for performing lower layer mobility.

According to an exemplary embodiment of the first exemplary aspect, the at least one memory further storing instructions that, when executed by the at least one processor, cause the apparatus at least to perform at least one of the following:
Transmitting (e.g. to a second apparatus according to the second exemplary aspect) a report on a layer 3 measurement of at least one of the following: a source cell or of the at least one candidate cell;
Transmitting (e.g. to a second apparatus) a report on a layer 1 measurement of at least one of the following: a source cell or of the at least one candidate cell.

According to an exemplary embodiment of the first exemplary aspect, the conditional configuration comprises one of the following:
(a) a dual configuration, wherein the dual configuration either
(i) being a lower layer mobility configuration having a pointer to a conditional handover configuration; or
(ii) being a conditional handover configuration having a pointer to a lower layer mobility configuration; wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular a second apparatus (in particular a source network node providing the source cell) adjusted a lower layer mobility condition to a conditional handover condition.

According to an exemplary embodiment of the first exemplary aspect, the at least one memory further storing instructions that, when executed by the at least one processor, cause the apparatus to perform:
(e.g. in response to transmitting a report on a layer 1 measurement) Receiving a network command for a handover, wherein the network command for the handover is a handover trigger (e.g. to a target cell of the at least one candidate cell);
In response to receiving the network command for the handover, initiating the handover between a source cell and one target cell of the at least one candidate cell, wherein the initiating the handover in particular comprises initializing a random access procedure with the target cell.

According to an exemplary embodiment of the first exemplary aspect, the at least one memory further storing instructions that, when executed by the at least one processor, cause the apparatus at least to perform: in response to not receiving the network command for the handover, determining the handover based on a layer 3 measurement of at least one candidate cell or a layer 1 measurement.

According to an exemplary embodiment of the first exemplary aspect, the conditional configuration information comprises a handover condition or information on the handover condition,
wherein in particular the handover condition comprises at least one of the following: a conditional handover condition or a lower layer mobility condition; and
wherein the handover condition in particular comprises at least one of the following: an inequality or threshold condition; and
wherein in particular the conditional configuration information further comprises information on at least two timers.

According to an exemplary embodiment of the first exemplary aspect, the determining the handover comprises the following and the at least one memory further storing instructions that, when executed by the at least one processor, cause the apparatus at least to perform the following:
Evaluating the handover condition based on the layer 3 measurement or the layer 1 measurement;
Based on evaluating the handover condition is present, initiating the handover between the source cell and one target cell of the at least one candidate cell, wherein the initiating the handover in particular comprises initializing a random access procedure with the target cell; and optionally transmitting (e.g. to the second apparatus) a notification that the handover condition is present and that the handover is initiated.

According to an exemplary embodiment of the first exemplary aspect, the determining the handover comprises (and the at least one memory further storing instructions that, when executed by the at least one processor, cause the apparatus to perform):
Evaluating the handover condition based on the layer 3 measurement or the layer 1 measurement;
Based on evaluating the handover condition is present, starting at least one timer and either (i) before expiry of the at least one timer, initiating the handover between the source cell and the target cell (e.g. determining a handover completion condition,) and stopping the at least one timer, or (ii) in response to expiring of the at least one timer (e.g. determining that a handover completion condition is not present and) initiating cell recovery to one of the at least one candidate cell;
   and optionally transmitting (e.g. to the second apparatus) a notification that the handover condition is present and that the handover is initiated.

According to an exemplary embodiment of the first exemplary aspect, the conditional configuration information further comprises information on at least two timers, the at least one memory further storing instructions that, when executed by the at least one processor, cause the apparatus at least to perform:
Evaluating the handover condition based on a layer 1 measurement (e.g. of the at least one candidate cell);
Based on evaluating the handover condition is present, starting a first timer of the at least two timers;
   Optionally Transmitting (e.g. to the second apparatus) a report on a layer 1 measurement (e.g. of the source cell and) of the at least one candidate cell; and either
   (i) before expiry of the first timer,
   Optionally, transmitting (e.g. to the second apparatus) a/the report on a layer 1 measurement (e.g. of the source cell and) of the at least one candidate cell;
   (in response to transmitting the report on the layer 1 measurement,) receiving (e.g. from the second apparatus, e.g. a source network node providing a source cell) a network command for the handover, wherein the network command for the handover is a handover trigger; (e.g. the handover trigger informing the apparatus to perform the initiating the handover)
   in response to receiving the handover trigger, stopping the first timer and initiating the handover between the source cell and a target cell of the at least one candidate cell;
   (ii) before expiry of the first timer,
   Optionally Transmitting (e.g. to the second apparatus) a/the report on a layer 1 measurement (e.g. of the source cell and) of the at least one candidate cell;
   (in response to transmitting the report on the layer 1 measurement,) Receiving (e.g. from the second apparatus, e.g. a source network node providing a source cell) a network command for the handover,
   wherein the network command for the handover is a stay trigger;
   in response to receiving the stay trigger, stopping the first timer and starting a second timer of the at least two timers, and either,
   (a) before expiry of the second timer, receiving a handover trigger and stopping the second timer, and initiating the handover between the source cell and one target cell; or
   (b) in response to expiring of the second timer without receiving a handover trigger, repeating the described steps starting from the evaluation of the handover condition based on the layer 1 measurement, (e.g. transmitting a further report on a further layer 1 measurement of a source cell and of the at least one candidate cell, re-evaluating the handover condition based on the further layer 1 measurement; and initiating the handover between the source cell and one target cell);
   (iii) in response to expiring of the first timer (e.g. without receiving a network command), initiating the handover between the source cell and a target cell of the at least one candidate cell.

According to an exemplary embodiment of the first exemplary aspect, the at least one memory further storing instructions that, when executed by the at least one processor, cause the apparatus at least to perform:
Subsequent to initiating the handover, determining a handover completion condition;
Based on determining the handover completion condition is not present, initiating cell recovery to one of the at least one candidate cell (e.g. provided by at least one candidate network node).

According to an exemplary embodiment of the first exemplary aspect, the conditional configuration or the conditional configuration information comprises an execution condition enabling the first apparatus to autonomously perform initiating the handover, and optionally the at least one memory further storing instructions that, when executed by the at least one processor, cause the apparatus at least to perform:
Autonomously initiating the handover between the source and one target cell of the at least one candidate cell.

According to an exemplary embodiment of the first exemplary aspect, the at least one memory further storing instructions that, when executed by the at least one processor, cause the apparatus at least to perform:
Transmitting (e.g. to the source network node) an information indicative of a target network node based on the layer 1 measurement (e.g. of the target network node).

According to an exemplary embodiment of the first exemplary aspect, the at least one memory further storing instructions that, when executed by the at least one processor, cause the apparatus at least to perform:
Storing (e.g. in the at least one memory) the conditional configuration (e.g. for the at least one candidate cell) and the conditional configuration information;
Receiving (e.g. from the second apparatus, e.g. the source network node) an indication of a release of a handover condition;
Consolidate the conditional configuration and/or the conditional configuration information based on the indication of the release of the handover condition, in particular removing (e.g. from the conditional configuration and/or the conditional configuration information) or ignoring the released handover condition.

For instance, receiving an indication of a release of a handover condition may comprise receiving (e.g. from the second apparatus, e.g. a second apparatus according to the second or seventh exemplary aspect) a notification that the handover condition is released (e.g. by the third apparatus, e.g. a third apparatus according to the third or eighth exemplary aspect). An indication of a release of a handover condition may e.g. be or comprise a message that a second apparatus sends to the first apparatus, in case the second apparatus transmits a message to the third apparatus indicating to release conditional handover preparations (e.g. a notification of the UE that the gNB-DU sends a release message to the CU).

According to a second exemplary aspect, an apparatus (e.g. a (source) network node or a gNB-DU) is disclosed, the apparatus comprising at least one processor; and at least one memory storing instructions that, when executed by the at least one processor, cause the apparatus at least to perform:
Transmitting (e.g. to a first apparatus according to the first exemplary aspect) a conditional configuration and a conditional configuration information.

According to an exemplary embodiment of the second exemplary aspect, the at least one memory further storing instructions that, when executed by the at least one processor, cause the apparatus at least to perform:
Receiving (e.g. from a first apparatus) a report on a layer 3 measurement of a source cell provided by the second apparatus and of at least one candidate cell (e.g. provided by at least one candidate network node);
Transmitting the report on the layer 3 measurement (e.g. to the third apparatus);
In response to the transmitting the report on the layer 3 measurement, receiving (e.g. from the third apparatus) a conditional configuration and a conditional configuration information (e.g. for the at least one candidate cell);
Transmitting the conditional configuration and the conditional configuration information (e.g. to the first apparatus).

According to an exemplary embodiment of the second exemplary aspect, the conditional configuration comprises one of the following:
(a) a dual configuration, wherein the dual configuration either
(i) being a lower layer mobility configuration having a pointer to a conditional handover configuration; or
(ii) being a conditional handover configuration having a pointer to a lower layer mobility configuration; wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular the second apparatus adjusted a lower layer mobility condition to the conditional handover condition.

According to an exemplary embodiment of the second exemplary aspect, the conditional configuration or the conditional configuration information comprises an execution condition enabling a first apparatus to autonomously perform the initiating handover.

According to an exemplary embodiment of the second exemplary aspect, the at least one memory further storing instructions that, when executed by the at least one processor, cause the apparatus at least to perform:
Receiving (e.g. from the first apparatus) a report on a layer 1 measurement (e.g. for lower layer mobility) of the at least one candidate cell;
Determining whether a handover of a first apparatus to a candidate cell (e.g. provided by a candidate network node) is to be performed based on the report on the layer 1 measurement;
Based on determining that the handover of the first apparatus to the candidate cell is to be performed, transmitting (e.g. to the first apparatus) a network command for a handover, wherein the network command for the handover is a handover trigger;
Optionally transmitting a message (e.g. to a third apparatus according to the third exemplary aspect) indicating to release conditional handover preparations.

According to an exemplary embodiment of the second exemplary aspect, the at least one memory further storing instructions that, when executed by the at least one processor, cause the apparatus at least to perform:
Receiving (e.g. from the first apparatus) a report on a layer 1 measurement (e.g. for lower layer mobility) of the at least one candidate cell;
Determining whether a handover of a first apparatus to a candidate cell is to be performed based on the report on the layer 1 measurement;
Based on determining that the handover of the first apparatus to the candidate cell is not to be performed, transmitting (e.g. to the first apparatus) a network command for a handover, wherein the network command for the handover is a stay trigger.

According to an exemplary embodiment of the second exemplary aspect, the at least one memory further storing instructions that, when executed by the at least one processor, cause the apparatus at least to perform:
Receiving (e.g. from the first apparatus) an information indicative of a target cell (e.g. provided by a target network node) based on a layer 1 measurement (e.g. of the at least one candidate cell or the target cell);
Transmitting the information indicative of the target cell (e.g. to the third apparatus).

According to an exemplary embodiment of the second exemplary aspect, the conditional configuration information comprises a handover condition or information on the handover condition, wherein in particular the handover condition comprises at least one of the following: a conditional handover condition or a lower layer mobility condition; and wherein the handover condition in particular comprises at least one of the following: an inequality or threshold condition; and wherein in particular the conditional configuration information further comprises information on at least two timers.

According to an exemplary embodiment of the second exemplary aspect, the at least one memory further storing instructions that, when executed by the at least one processor, cause the apparatus at least to perform:
Transmitting (e.g. to the first apparatus) an indication of a release of a handover condition.

According to an exemplary embodiment of the second exemplary aspect, the at least one memory further storing instructions that, when executed by the at least one processor, cause the apparatus at least to perform:
Receiving (e.g. from the third apparatus) a flag indicating whether the conditional configuration comprises a dual configuration, a common configuration, a lower layer mobility configuration comprising a lower layer mobility condition, or a lower layer mobility configuration and a conditional handover configuration, and optionally
In response to receiving the flag, suspending, cancelling, blocking, or postponing at least one certain procedure.

According to an exemplary embodiment of the second exemplary aspect, the at least one memory further storing instructions that, when executed by the at least one processor, cause the apparatus at least to perform:
In response to receiving (e.g. from the third apparatus) the conditional configuration and the conditional configuration information;
Determining whether a conditional handover condition is comprised by the conditional configuration information;
Based on determining that a conditional handover condition is comprised by the conditional configuration information, adjusting a lower layer mobility condition to the conditional handover condition (e.g. the LLM condition detects the same radio condition as the CHO condition).

According to an exemplary embodiment of the second exemplary aspect, the at least one memory further storing instructions that, when executed by the at least one processor, cause the apparatus at least to perform:
Receiving (e.g. from the first apparatus) a notification that a handover condition is present and that the handover is initiated;
In response to receiving (e.g. from the first apparatus) the notification that the handover condition is present and that the handover is initiated, transmitting (e.g. to the third apparatus) a further notification that the handover condition is present and that the handover is initiated.

According to an exemplary embodiment of the second exemplary aspect, the at least one memory further storing instructions that, when executed by the at least one processor, cause the apparatus at least to perform:
Receiving (e.g. from the third apparatus) a flag indicating that the conditional configuration comprises a common configuration and an identifier of the common configuration; and optionally
Transmitting (e.g. to the first apparatus) a network command for a handover, wherein the network command for the handover is a handover trigger, the handover trigger comprising the identifier of the common configuration; and optionally
Suspending, cancelling, or postponing at least one certain procedure.

According to a third exemplary aspect, an apparatus (e.g. a gNB-CU) is disclosed, the apparatus comprising at least one processor; and at least one memory storing instructions that, when executed by the at least one processor, cause the apparatus at least to perform:
Receiving (e.g. from a second apparatus) a report on a layer 3 measurement (e.g. of a source cell and) of at least one candidate cell provided by at least one candidate network node;
In response to the receiving the report on the layer 3 measurement, transmitting, to the at least one candidate network node, a setup request indicative of a preparation of the at least one candidate cell for a conditional configuration of the at least one candidate cell, wherein the conditional configuration comprises one of the following:
   (a) a dual configuration, wherein the dual configuration either
   (i) being a lower layer mobility configuration having a pointer to a conditional handover configuration; or
   (ii) being a conditional handover configuration having a pointer to a lower layer mobility configuration; wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
   (b) a common configuration, wherein the common configuration is a conditional handover configuration that enables lower layer mobility based on a layer 1 measurement;
   (c) a lower layer mobility configuration comprising a lower layer mobility condition;
   (d) a lower layer mobility configuration and a conditional handover configuration;
In response to the transmitting the setup request, receiving from the at least one candidate network node a setup response indicative of a conditional configuration of the at least one candidate cell;
Based on receiving the setup response, transmitting (e.g. to the second apparatus) the conditional configuration (e.g. for the at least one candidate cell) and conditional configuration information.

According to an exemplary embodiment of the third exemplary aspect, the conditional configuration information comprises a handover condition or information on the handover condition, wherein in particular the handover condition comprises at least one of the following: a conditional handover condition or a lower layer mobility condition; and
wherein the handover condition in particular comprises at least one of the following: an inequality or threshold condition; and wherein in particular the conditional configuration information further comprises information on at least two timers.

According to an exemplary embodiment of the third exemplary aspect, the at least one memory further storing instructions that, when executed by the at least one processor, cause the apparatus at least to perform:

In response to the setup request being indicative of a preparation of the at least one candidate cell (or candidate network node) for a conditional configuration of the at least one candidate cell (or candidate network node), wherein the conditional configuration comprises a lower layer mobility configuration and a conditional handover configuration,
receiving from the at least one candidate network node an information indicative of at least one dual configuration of the at least one candidate cell (or candidate network node).

According to an exemplary embodiment of the third exemplary aspect, the at least one memory further storing instructions that, when executed by the at least one processor, cause the apparatus at least to perform:
Receiving an information indicative of a target cell (or target network node) from a second apparatus.

According to an exemplary embodiment of the third exemplary aspect, the at least one memory further storing instructions that, when executed by the at least one processor, cause the apparatus at least to perform:
Transmitting (e.g. to the second apparatus) a flag indicating whether the conditional configuration comprises a dual configuration, a common configuration, a lower layer mobility configuration comprising a lower layer mobility condition, or a lower layer mobility configuration and a conditional handover configuration (e.g. the flag enabling the second apparatus to suspend, cancel, block, or postpone at least one certain procedure).

According to an exemplary embodiment of the third exemplary aspect, the at least one memory further storing instructions that, when executed by the at least one processor, cause the apparatus at least to perform:
Transmitting (e.g. to the second apparatus) a flag indicating that the conditional configuration comprises a common configuration and an identifier of the common configuration.

According to an exemplary embodiment of the third exemplary aspect, the at least one memory further storing instructions that, when executed by the at least one processor, cause the apparatus at least to perform:
Receiving a message (e.g. from the second apparatus) indicating to release conditional handover preparations;
In response to the receiving the message indicating to release conditional handover preparations, releasing according conditional handover preparations.

According to an exemplary embodiment of the third exemplary aspect, the at least one memory further storing instructions that, when executed by the at least one processor, cause the apparatus at least to perform:
Receiving (e.g. from the second apparatus) a notification that the handover condition is present and that the handover is initiated;
In response to the receiving the notification that the handover condition is present and that the handover is initiated, indicating, to a target network node of the at least one candidate network node, to initiate data forwarding to the first apparatus.

According to a fourth exemplary aspect, a method is disclosed, the method comprising the steps the apparatus of the first, second, and/or third exemplary aspect is caused to perform, configured to perform, or has means for. The method may for instance be performed and/or controlled by an/the apparatus, for instance a server, a server cloud, a gNB, and/or a mobile entity (e.g., a mobile telecommunication device or a mobile phone or a user equipment).

Alternatively, this method may be performed and/or controlled by more than one apparatus, for instance a server cloud comprising at least two servers or a system of apparatus, e.g. a system comprising at least one gNB and at least one UE. For instance, the method may be performed and/or controlled by using at least one processor of an/the apparatus.

According to a fifth exemplary aspect, a system is disclosed, the system comprising at least one first apparatus according to the first exemplary aspect, at least one second apparatus according to the second exemplary aspect, and at least one third apparatus according to the third exemplary aspect.

According to a fifth exemplary aspect, a computer program product is disclosed, the computer program product when executed by a processor of an apparatus causing said apparatus to perform a method according to the fourth exemplary aspect.

According to a further exemplary aspect, a computer program is disclosed, the computer program when executed by a processor causing an apparatus, for instance a server, to perform and/or control the actions of the method according to the second exemplary aspect.

According to a further exemplary aspect, a computer readable storage medium is disclosed, the computer readable storage medium comprising a computer program product according to the fourth exemplary aspect.

(E.g. alternatively or additionally to the exemplary apparatus according to the first exemplary aspect,) According to a sixth exemplary aspect, an apparatus (e.g. a mobile entity or UE) is disclosed, the apparatus comprising at least one processor; and at least one memory storing instructions that, when executed by the at least one processor, cause the apparatus at least to perform or the apparatus comprising means for:
Transmitting (e.g. to a second apparatus (e.g. an apparatus according to the seventh exemplary aspect)) a report on a layer 3 measurement (e.g. of a source cell and) of at least one candidate cell;
Transmitting a report on a layer 1 measurement of at least one of: the source cell or the at least one candidate cell (e.g. transmitting a report on a layer 1 measurement of the source cell and of the at least one candidate cell);
Optionally, receiving (e.g. from the source network node, e.g. in response to transmitting the report on the layer 1 and/or the layer 3 measurement) at least one configuration (e.g. RRC reconfiguration, the at least one configuration may e.g. comprise a conditional configuration and a conditional configuration information) for the at least one candidate cell (or candidate network node), the at least one configuration comprising the handover condition or comprising information on the handover condition (e.g. enabling the apparatus to determine the handover condition);
Evaluating a/the handover condition based on at least one of the following: the layer 3 measurement or the layer 1 measurement;
Based on evaluating the handover condition is present, initiating a handover between the source cell and one target cell of the at least one candidate cell;
Determining a handover completion condition;
Based on determining the handover completion condition is not present, initiating cell recovery.

The transmitting a report on a layer 3 measurement of a source cell may be a transmitting to a source network node. The transmitting a report on a layer 1 measurement of a source cell may be a transmitting to a source network node. The transmitting a report on a layer 1 measurement may be a transmitting a report on a layer 1 measurement for lower layer mobility (LLM), e.g. it may be a transmitting periodically a report on a layer 1 measurement. LLM may be understood in that a decision about a cell change is based on L1 measurements and is made in the MAC layer in a Distributed Unit (DU). A source/candidate/target network node may be split into a Distributed Unit and a Control Unit (CU). A CU may be understood as a logical node that includes gNB functions like transfer of user data, mobility control, Radio access network sharing, Positioning, Session Management etc., except those functions allocated exclusively to the DU. A DU may be understood as a logical node including a subset of gNB functions. Its operation may be controlled by the CU. A gNB may consist of a gNB-CU-CP, multiple gNB-CU-UPs and multiple gNB-DUs, which may provide multiple cells.

Determining a handover completion condition may be performed subsequent to initiating the handover. Determining the handover completion condition is not present may comprise determining a Handover Failure (HOF) or Radio Link Failure (RLF).

According to an exemplary embodiment of the sixth exemplary aspect, the handover condition comprises at least one of the following: a conditional handover condition or a lower layer mobility condition, wherein in particular a LLM condition comprises a layer 1/layer 2 condition.

According to an exemplary embodiment of the sixth exemplary aspect, the at least one memory further storing instructions that, when executed by the at least one processor, cause the apparatus at least to perform:
Receiving (e.g. from the source network node) at least one configuration (e.g. RRC reconfiguration) for the at least one candidate cell (or candidate network node), the at least one configuration comprising the handover condition or comprising information on the handover condition (e.g. enabling the apparatus to determine the handover condition);
In particular in case the at least one configuration comprises information on the handover condition, determining the handover condition based on the information on the handover condition;
Optionally initiating a handover between the source cell and one target cell by applying the at least on configuration for the target cell.

According to an exemplary embodiment of the sixth exemplary aspect, the at least one configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility (e.g. based on the layer 1 measurement);
(c) a lower layer mobility configuration comprising a lower layer mobility condition.

According to an exemplary embodiment of the sixth exemplary aspect, the at least one configuration comprises an execution condition enabling the apparatus to autonomously perform initiating the handover, and optionally the at least one memory further storing instructions that, when executed by the at least one processor, cause the apparatus at least to perform:
Autonomously initiating the handover between the source and one target cell of the at least one candidate cell.

According to an exemplary embodiment of the sixth exemplary aspect, the at least one memory further storing instructions that, when executed by the at least one processor, cause the apparatus at least to perform:
Receiving a handover trigger (e.g. from the source network node) to perform the initiating the handover, in particular receiving the handover trigger in layer 2 (or media access control layer).

According to an exemplary embodiment of the sixth exemplary aspect, the at least one memory further storing instructions that, when executed by the at least one processor, cause the apparatus at least to perform:
Based on evaluating the handover condition is present, perform the initiating the handover.

According to an exemplary embodiment of the sixth exemplary aspect, the at least one memory further storing instructions that, when executed by the at least one processor, cause the apparatus at least to perform:
Based on evaluating the handover condition is present, starting at least one timer; and at least one of the following:
(a) before expiry of the at least one timer either
   (i) (autonomously) initiating the handover between the source cell and the target cell, and stopping the at least one timer, and optionally transmitting (e.g. to the source network node) a notification that the handover condition is present and that the handover is initiated; or
   (ii) in response to receiving a handover trigger (e.g. on layer 2), initiating the handover between the source cell and the target cell and stopping the at least one timer; or
   (iii) in response to receiving a stay trigger (e.g. from the source network node), stopping the at least one timer, transmitting a further report on a further layer 1 measurement of a source cell and of the at least one candidate cell, re-evaluating the handover condition based on the further layer 1 measurement; and initiating the handover between the source cell and one target cell of the at least one candidate cell based on the handover condition; or
   (iv) receiving a stay trigger, from the source network node 101, and in response to receiving a stay trigger, stopping the at least one timer and starting at least one second timer, and either, (I) before expiry of the second timer, receiving a handover trigger (e.g. from the second apparatus (e.g. an apparatus according to the seventh exemplary aspect)), stopping the at least one second timer, and initiating the handover between the source cell and one target cell;
   Or (II) in response to expiring of the at least one second timer without receiving a handover trigger, e.g. repeating the (described) steps starting from the evaluation of the handover condition, e.g. transmitting a further report on a further layer 1 measurement of a source cell and of the at least one candidate cell, re-evaluating the handover condition based on the further layer 1 measurement; and initiating the handover between the source cell and one target cell; or
(b) in response to expiring of the at least one timer either
   (i) initiating the handover between the source cell and the target cell;
   (ii) determining that the handover completion condition is not present; or
   (iii) starting at least one second timer; and before expiry of the at least one timer autonomously perform the initiating the handover between the source cell and the target cell, and stopping the at least one timer; or in response to expiring of the at least one second timer determining the handover completion condition is not present.

For example, the at least one timer may comprise the at least two timers.

According to an exemplary embodiment of the sixth exemplary aspect, the at least one memory further storing instructions that, when executed by the at least one processor, cause the apparatus at least to perform:
Transmitting (e.g. to the source network node) an information indicative of a target network node based on the layer 1 measurement.

According to an exemplary embodiment of the sixth exemplary aspect, the at least one memory further storing instructions that, when executed by the at least one processor, cause the apparatus at least to perform:
Storing (e.g. in the at least one memory) the at least one configuration for the at least one candidate cell;
Receiving (e.g. from the source network node) an indication of a release of a handover condition, conditional handover configuration, or lower layer mobility configuration;
Consolidate the at least one configuration, in particular removing or ignoring the released handover condition, conditional handover configuration, or lower layer mobility configuration in the at least one configuration; or removing a pointer to a released conditional handover configuration or lower layer mobility configuration in the handover condition.

(E.g. alternatively or additionally to the exemplary apparatus according to the second exemplary aspect,) According to a seventh exemplary aspect, an apparatus (e.g. a (source) network node or a gNB-DU) is disclosed, the apparatus comprising at least one processor; and at least one memory storing instructions that, when executed by the at least one processor, cause the apparatus at least to perform or the apparatus comprising means for:
Receiving (e.g. from a first apparatus (e.g. an apparatus according to the sixth exemplary aspect, e.g. a mobile entity or UE) a report on a layer 3 measurement (e.g. of a source cell provided by the apparatus according to the seventh exemplary aspect and) of at least one candidate cell (e.g. provided by at least one candidate network node);
Receiving (e.g. from the first apparatus or mobile entity or UE) a report on a layer 1 measurement (e.g. for lower layer mobility) of at least one of the following: the source cell or the at least one candidate cell (e.g. receiving a report on a layer 1 measurement of the source cell and of the at least one candidate cell);
Transmitting the report on the layer 3 measurement to a third apparatus (e.g. an apparatus according to the eighth exemplary aspect) (e.g. via UL RRC message transfer message);
In response to the transmitting the report on the layer 3 measurement, receiving (e.g. from the third apparatus or a gNB-CU) at least one configuration (e.g. RRC reconfiguration) for the at least one candidate cell comprising a handover condition or comprising information on the handover condition (e.g. via DL RRC message transfer message);
Transmitting the at least one configuration to an apparatus according to the sixth exemplary aspect.

The apparatus according to the second and/or seventh exemplary aspect may be a gNB-DU, for example a gNB-DU providing a source cell for e.g. a first apparatus or an apparatus according to the first or sixth exemplary aspect According to an exemplary embodiment of the seventh exemplary aspect, the at least one configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility (e.g. based on the layer 1 measurement); or
(c) a lower layer mobility configuration comprising a lower layer mobility condition.

According to an exemplary embodiment of the seventh exemplary aspect, the at least one configuration comprises an execution condition enabling the first apparatus (e.g. the apparatus according to the sixth exemplary aspect) to autonomously perform the initiating the handover.

According to an exemplary embodiment of the seventh exemplary aspect, the at least one memory further storing instructions that, when executed by the at least one processor, cause the apparatus at least to perform:
Transmitting a handover trigger (e.g. to the first apparatus or mobile entity or UE), in particular transmitting the handover trigger in layer 2 (or media access control layer), for example transmitting a handover trigger in response to receiving a report on a layer 1 measurement and/or transmitting a handover trigger based on the layer 1 measurement.

According to an exemplary embodiment of the seventh exemplary aspect, the at least one memory further storing instructions that, when executed by the at least one processor, cause the apparatus at least to perform:
Receiving (e.g. from the first apparatus or mobile entity or UE) an information indicative of a target cell (or target network node) based on the layer 1 measurement;
Transmitting the information indicative of the target cell (or target network node) to the third apparatus (e.g. a gNB-CU).

According to an exemplary embodiment of the seventh exemplary aspect, the handover condition comprises at least one of the following: a conditional handover condition or a lower layer mobility condition, wherein in particular a LLM condition comprises a layer 1/layer 2 condition.

According to an exemplary embodiment of the seventh exemplary aspect, the at least one memory further storing instructions that, when executed by the at least one processor, cause the apparatus at least to perform:
Transmitting (e.g. to the first apparatus or mobile entity or UE) an indication of a release of a handover condition, conditional handover configuration, or lower layer mobility configuration.

According to an exemplary embodiment of the seventh exemplary aspect, the at least one memory further storing instructions that, when executed by the at least one processor, cause the apparatus at least to perform:
Receiving (e.g. from the third apparatus or gNB-CU) a flag indicating that the at least one configuration comprises a conditional handover condition and a lower layer mobility condition or comprises information on a conditional handover condition and a lower layer mobility condition (e.g. the flag enabling the apparatus to suspend, cancel, or postpone at least one certain procedure, for context release before a timer has expired); and optionally
Suspending, cancelling, or postponing the at least one certain procedure.

According to an exemplary embodiment of the seventh exemplary aspect, the at least one memory further storing instructions that, when executed by the at least one processor, cause the apparatus at least to perform:
Evaluating the report on the layer 1 measurement;
Based on the evaluating the report, transmitting a handover trigger (e.g. to the first apparatus).

According to an exemplary embodiment of the seventh exemplary aspect, the at least one memory further storing instructions that, when executed by the at least one processor, cause the apparatus at least to perform:
In response to receiving (e.g. from the third apparatus or gNB-CU) the at least one configuration (e.g. RRC reconfiguration);
Determining whether a conditional handover condition is comprised by the at least one configuration;
Based on determining that a conditional handover condition is comprised by the at least one configuration, adjusting a lower layer mobility condition to the conditional handover condition (e.g. the LLM condition detects the same radio condition as the CHO condition).

According to an exemplary embodiment of the seventh exemplary aspect, the at least one memory further storing instructions that, when executed by the at least one processor, cause the apparatus at least to perform:
Determining (e.g. in layer 2) whether a handover of a first apparatus (e.g. an apparatus according to the sixth exemplary aspect) to a candidate cell (e.g. provided by a candidate network node) is to be performed based on the report on the layer 1 measurement;
Based on determining that the handover of the first apparatus to the candidate cell is to be performed, transmitting a handover trigger (e.g. to the first apparatus);
Optionally transmitting a message (e.g. to the third apparatus) indicating to release conditional handover preparations.

According to an exemplary embodiment of the seventh exemplary aspect, the at least one memory further storing instructions that, when executed by the at least one processor, cause the apparatus at least to perform:
Determining (e.g. in layer 2) whether a handover of a first apparatus to a candidate cell is to be performed based on the report on the layer 1 measurement;
Based on determining that the handover of a first apparatus to a candidate cell is not to be performed, transmitting a stay trigger (e.g. to the first apparatus).

According to an exemplary embodiment of the seventh exemplary aspect, the at least one memory further storing instructions that, when executed by the at least one processor, cause the apparatus at least to perform:
Receiving (e.g. from the first apparatus) a notification that the handover condition is present and that the handover is initiated;
In response to receiving (e.g. from the first apparatus) the notification that the handover condition is present and that the handover is initiated, transmitting (e.g. to the third apparatus) a further notification that the handover condition is present and that the handover is initiated (e.g. enabling the third apparatus to initiate data forwarding in time).

According to an exemplary embodiment of the seventh exemplary aspect, the at least one memory further storing instructions that, when executed by the at least one processor, cause the apparatus at least to perform:
Receiving (e.g. from a third apparatus or gNB-CU) a flag indicating that the at least one configuration comprises a common configuration and an identifier of the common configuration (e.g. the flag enabling the seventh apparatus to suspend, cancel, or postpone at least one certain procedure, for example context release before a timer has expired; for instance the identifier enabling the apparatus to trigger the at least one configuration, e.g. the identifier enabling the apparatus to trigger the application of at least one configuration by the UE); and optionally
(In response to receiving the flag,) Transmitting (e.g. to the first apparatus) a handover trigger comprising the identifier of the common configuration; and optionally
Suspending, cancelling, or postponing the at least one certain procedure.

According to an exemplary embodiment of the seventh exemplary aspect, the at least one memory further storing instructions that, when executed by the at least one processor, cause the apparatus at least to perform:
Receiving (e.g. from a third apparatus or gNB-CU) a flag indicating that the at least one configuration comprises a lower layer mobility condition (e.g. the flag enabling the seventh apparatus to block at least one certain procedure, for example context release before a timer has expired);
Optionally, (in response to receiving the flag) transmitting (e.g. to the first apparatus) a handover trigger comprising the identifier of the common configuration; and
Optionally blocking the at least one certain procedure.

According to an exemplary embodiment of the seventh exemplary aspect, the at least one memory further storing instructions that, when executed by the at least one processor, cause the apparatus at least to perform:
Transmitting (e.g. to the first apparatus) information for setting at least one timer (e.g. enabling enhanced control of the mobility procedure).

(E.g. alternatively or additionally to the exemplary apparatus according to the third exemplary aspect,) According to a eighth exemplary aspect, an apparatus is disclosed, the apparatus comprising at least one processor; and at least one memory storing instructions that, when executed by the at least one processor, cause the apparatus at least to perform or the apparatus comprising means for:
Receiving (e.g. from a seventh apparatus (e.g. an apparatus according to the seventh exemplary aspect), e.g. a gNB-DU) a report on a layer 3 measurement (e.g. of a source cell and) of at least one candidate cell provided by at least one candidate network node;
In response to the receiving the report on the layer 3 measurement, transmitting, to the at least one candidate network node, a setup request (e.g. a UE context setup request) indicative of a preparation of the at least one candidate cell (provided by the at least one candidate network node) for at least one configuration of the at least one candidate cell (e.g. a preparation of at least one configuration informs the DU of which kind of configuration should be applied, e.g. dual preparation);
In response to the transmitting the setup request, receiving from the at least one candidate network node a setup response indicative of the at least one configuration of the at least one candidate cell;
Based on receiving the setup response, transmitting (e.g. to the second apparatus) the at least one configuration for the at least one candidate cell, the at least one configuration comprising a handover condition or comprising information on the handover condition (e.g. enabling the first apparatus (e.g. an apparatus according to the sixth exemplary aspect) to determine the handover condition).

According to an exemplary embodiment of the eighth exemplary aspect, the handover condition comprises at least one of the following: a conditional handover condition or a lower layer mobility condition, wherein in particular a LLM condition comprises a layer 1/layer 2 condition.

The apparatus according to the third and/or eighth exemplary aspect may be a gNB-CU (in particular a gNB-CU-CP), for example controlling a second apparatus or gNB-DU providing a source cell for e.g. a first apparatus (e.g. according to the second and/or seventh exemplary aspect) and for example controlling a gNB-DU providing a candidate or target cell.

According to an exemplary embodiment of the third exemplary aspect, the at least one configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility (e.g. based on the layer 1 measurement); or
(c) a lower layer mobility configuration comprising a lower layer mobility condition.

According to an exemplary embodiment of the eighth exemplary aspect, wherein in response to the setup request being not indicative of a preparation of at least one dual configuration, receiving from the at least one candidate network node an information (e.g. within the setup response) indicative of at least one dual configuration of the at least one candidate cell.

According to an exemplary embodiment of the eighth exemplary aspect, the at least one memory further storing instructions that, when executed by the at least one processor, cause the apparatus at least to perform:
Receiving an information indicative of a target cell (or target network node) from a second apparatus (e.g. a gNB-DU).

According to an exemplary embodiment of the eighth exemplary aspect, the at least one memory further storing instructions that, when executed by the at least one processor, cause the apparatus at least to perform:
Transmitting (e.g. to a second apparatus or gNB-DU) a flag indicating that the at least one configuration comprises a lower layer mobility condition (e.g. the flag enabling the second apparatus to block at least one certain procedure, for example context release before a timer has expired).

According to an exemplary embodiment of the eighth exemplary aspect, the at least one memory further storing instructions that, when executed by the at least one processor, cause the apparatus at least to perform:
Transmitting (e.g. to a second apparatus or gNB-DU) a flag indicating that the at least one configuration comprises a conditional handover condition and a lower layer mobility condition or comprises information on a conditional handover condition and a lower layer mobility condition, the flag e.g. enabling the second apparatus to suspend, cancel, or postpone at least one certain procedure, for context release before a timer has expired.

For example, transmitting the flag indicating that the at least one configuration comprises a conditional handover condition and a lower layer mobility condition or comprises information on a conditional handover condition and a lower layer mobility condition, in case the at least one configuration comprises a conditional handover condition and a lower layer mobility condition or comprises information on a conditional handover condition and a lower layer mobility condition.

According to an exemplary embodiment of the eighth exemplary aspect, for example, in case the at least one configuration comprises a conditional handover condition and a lower layer mobility condition or comprises information on a conditional handover condition and a lower layer mobility condition, transmitting the flag indicating that the at least one configuration comprises a conditional handover condition and a lower layer mobility condition or (indicating that the at least one configuration) comprises information on a conditional handover condition and a lower layer mobility condition (respectively).

According to an exemplary embodiment of the eighth exemplary aspect, the at least one memory further storing instructions that, when executed by the at least one processor, cause the apparatus at least to perform:
Transmitting (e.g. to a second apparatus or gNB-DU) a flag indicating that the at least one configuration comprises a common configuration and an identifier of the common configuration (e.g. the flag enabling the second apparatus to suspend, cancel, or postpone at least one certain procedure, for example context release before a timer has expired, the identifier enabling the second apparatus to trigger the at least one configuration).

According to an exemplary embodiment of the eighth exemplary aspect, the at least one memory further storing instructions that, when executed by the at least one processor, cause the apparatus at least to perform:
Transmitting (e.g. to a second apparatus or gNB-DU) a flag indicating that the at least one configuration comprises lower layer mobility condition (e.g. the flag enabling the second apparatus to block at least one certain procedure, for example context release before a timer has expired).

According to an exemplary embodiment of the eighth exemplary aspect, the at least one memory further storing instructions that, when executed by the at least one processor, cause the apparatus at least to perform:
Receiving a message (e.g. from the second apparatus) indicating to release conditional handover preparations;
In response to the receiving the message indicating to release conditional handover preparations, releasing according conditional handover preparations, for example releasing the preparation from at least one candidate network for the at least one configuration of the at least one candidate cell.

According to an exemplary embodiment of the eighth exemplary aspect, the at least one memory further storing instructions that, when executed by the at least one processor, cause the apparatus at least to perform:
Receiving (e.g. from the second apparatus) a notification that the handover condition is present and that the handover is initiated;
In response to the receiving the notification that the handover condition is present and that the handover is initiated, indicating, to a target network node of the at least one candidate network node, to initiate data forwarding to the first apparatus (e.g. UE).

The above-disclosed apparatus according to any aspect may be a module or a component for a device, for example a chip. Alternatively, the disclosed apparatus according to any aspect may be a device, for instance a server, a mobile entity, or a base station. The disclosed apparatus according to any aspect may comprise only the disclosed components, for instance means, processor, memory, or may further comprise one or more additional components. The above-disclosed apparatus according to any aspect may be an apparatus for or enabling lower layer mobility, e.g. an apparatus comprising means for, or being configured for, or caused to perform lower layer mobility. The above-disclosed apparatus according to any aspect may be an apparatus enabling handover and/or cell recovery, e.g. an apparatus comprising means for, or being configured for, or caused to perform handover and/or cell recovery.

The means of an apparatus according to any exemplary aspect can be implemented in hardware and/or software. They may comprise for instance at least one processor for executing computer program code for performing the required functions, at least one memory storing the program code, or both. Alternatively, they could comprise for instance circuitry that is designed or configured to implement the required functions, for instance implemented in a chipset or a chip, like an integrated circuit. In general, the means may comprise for instance one or more processing means or processors. The apparatus may for instance be or comprise a mobile entity (e.g., a mobile (telecommunication) device or a mobile phone or a user equipment (UE)).

As used in this application, the term “circuitry” may refer to one or more or all of the following:
(a) hardware-only circuit implementations (such as implementations in e.g. analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

According to some or all disclosed exemplary aspects, a source cell may be a cell currently connected to the first apparatus e.g. for data transfer. The source cell may be provided by a source network node, e.g. a gNB-DU. A candidate cell may be a cell that can be measured by the first apparatus, e.g. which is close enough to the first apparatus to be measured, and may be prepared by the third apparatus for cell handover. The at least one candidate cell may be provided by at least one candidate network node, e.g. a candidate gNB-DU. A target cell may be a cell of the at least one candidate cell(s) for which the handover condition is present or holds. The target cell may be provided or controlled by a target network node (comprised in) the at least one candidate network node. The handover or cell change between a source cell provided by a source network node and a target cell provided by a target network node may comprise a handover between the source network node and the target network node. In some cases the source network node and the target network node may be the same network node.

According to some or all disclosed exemplary aspects, a handover condition may be a condition that is to be met/present so that handover may be initiated, it may comprise at least one of the following: a threshold value (or threshold condition) that for instance needs to be exceeded for the handover condition to be met/present, or an inequality (condition) that for instance needs to be fulfilled for the handover condition to be met/present. An inequality (condition) may e.g. be or comprise that a value comprising a measurement (result) from a candidate or target cell exceeds a value comprising a measurement (result) from the source cell, the measurement may e.g. be or be based on a layer 1 or layer 3 measurement. A handover condition may e.g. comprise a timer, e.g. the at least one timer, e.g. the timer may enable (e.g. an apparatus according to the first exemplary aspect) to consider a time to trigger (the handover), so that the decision for triggering the handover may be based on more than one measurement, e.g. more than one layer 1 measurement.

A CHO condition may e.g. comprise up to two CHO execution conditions per each candidate (target) cell. In case there are two CHO execution conditions provided, those are linked with conjunction relationship, so both need to be fulfilled before the handover may be initiated. A CHO condition may be based on a layer 3 measurement and/or on a layer 1 measurement (in particular when a layer 3 filter is optionally disabled).

A LLM condition may e.g. have a similar structure then a CHO condition, it may e.g. comprise that a value comprising a measurement (result) from a candidate or target cell exceeds a value comprising a measurement (result) from the source cell, the measurement (result) may e.g. be or be based on a layer 1 or layer 3 measurement. A LLM condition may be based on a layer 1 measurement.

According to some or all disclosed exemplary aspects, a handover completion condition may be a condition that indicates whether a handover has been completed/performed successfully. In case a handover condition is not present, the handover may not be completed successfully and e.g. HOF or RLF may be present. The handover completion may be e.g. present in case the first apparatus after initiating a handover successfully completes the handover (to the target cell); in case the first apparatus after initiating a handover does not complete the handover successfully, the handover completion condition may not be present.

Initiating a handover may be e.g. a UE trying to perform the handover. Successful completion of the handover may be determined later using the handover completion condition.

An indication of a release of a handover condition may be an indication that a third apparatus releases a handover condition, e.g. an indication (e.g. a notification) that a second apparatus transmits to the first apparatus, e.g. in case it transmits a message to the third apparatus indicating to release conditional handover preparations. For example, an indication of a release of a handover condition may be a notification of the first apparatus (e.g. UE) that the second apparatus (e.g. gNB-DU) transmits a release message to the third apparatus (e.g. gNB-CU).

According to some or all disclosed exemplary aspects, cell recovery may be understood as performing a handover to a candidate cell of the at least one candidate cell(s) that has been configured for handover e.g. by a third apparatus, e.g. a gNB-CU, after the handover to the target cell failed, e.g. due to a signal loss, e.g. a loss of a report on a layer 1 measurement or a loss of a trigger from a second apparatus, e.g. a source gNB-DU. Cell recovery may be a conditional handover (CHO) recovery. CHO Recovery (may be configured by the network, e.g. a gNB-CU) may be performed e.g. provided at least more than one candidate cell is prepared for a CHO handover (CHO candidate cell). In CHO recovery, the first apparatus (e.g. UE) may first trigger a cell selection procedure and if the selected cell (as per cell selection procedure) is a CHO candidate cell, the first apparatus may execute CHO to the selected target cell. Cell recovery may be a lower layer mobility (LLM) recovery. LLM recovery may be understood as the following process: first the UE may trigger a cell selection procedure and if the selected cell (as per cell selection procedure) is a LLM candidate cell, the UE executes HO to the selected target cell. If a first apparatus (e.g. a UE) is configured with configurations for LLM for a candidate cell, these configurations can be used for Handover Failure and RLF recovery if the best cell selected from cell reselection is one of the prepared candidate cells of LLM. Depending on the prepared configurations, CU/DU may also indicate whether given configuration is suitable for LLM recovery (e.g. at the time of configuration).

According to some or all disclosed exemplary aspects, a preparation of the at least one candidate network for at least one configuration of the at least one candidate network node may be understood as a preparation of at least one configuration that may e.g. inform the second apparatus of which kind of configuration should be applied, e.g. dual preparation. A preparation of the at least one candidate network may be setting up the context in the candidate/target network node.

The apparatus according to the second and/or seventh exemplary aspect may be a gNB-DU, for example a gNB-DU providing a source cell for e.g. a first apparatus or an apparatus according to the first or sixth exemplary aspect. The apparatus according to the third and/or eighth exemplary aspect may be a gNB-CU (in particular a gNB-CU-CP), for example controlling a second apparatus or gNB-DU providing a source cell for e.g. a first apparatus (e.g. according to the second and/or seventh exemplary aspect) and for example controlling a gNB-DU providing a candidate or target cell.

According to some or all disclosed exemplary aspects, the transmitting a report on a layer 3 measurement of a source cell may be a transmitting to a source network node. The transmitting a report on a layer 1 measurement of a source cell may be a transmitting to a source network node. The transmitting a report on a layer 1 measurement may be a transmitting a report on a layer 1 measurement for lower layer mobility (LLM), e.g. it may be a transmitting periodically a report on a layer 1 measurement. LLM may be understood in that a decision about a cell change is based on L1 measurements and is made in the MAC layer in a Distributed Unit (DU). A source/candidate/target network node may be split into a Distributed Unit and a Control Unit (CU). A CU may be understood as a logical node that includes gNB functions like transfer of user data, mobility control, Radio access network sharing, Positioning, Session Management etc., except those functions allocated exclusively to the DU. A DU may be understood as a logical node including a subset of gNB functions. Its operation may be controlled by the CU. A gNB may consist of a gNB-CU-CP, multiple gNB-CU-UPs and multiple gNB-DUs, which may provide multiple cells.

According to some or all disclosed exemplary aspects, determining a handover completion condition may be performed subsequent to initiating the handover. Determining the handover completion condition is not present may comprise determining a Handover Failure (HOF) or Radio Link Failure (RLF).

For example, features according to the sixth exemplary aspect may equally be features of an apparatus according to the first exemplary aspect (and vice versa) and may for instance further specify features of an apparatus according to the first exemplary aspect. For example, features according to the seventh exemplary aspect may equally be features of an apparatus according to the second exemplary aspect (and vice versa) and may for instance further specify features of an apparatus according to the second exemplary aspect. For example, features according to the eighth exemplary aspect may equally be features of an apparatus according to the third exemplary aspect (and vice versa) and may for instance further specify features of an apparatus according to the third exemplary aspect.

In the following, exemplary features and exemplary embodiments of all aspects will be described in further detail.

According to some or all disclosed exemplary aspects, the handover condition comprises at least one of the following: a conditional handover condition or a lower layer mobility condition, wherein a LLM condition in particular comprises a layer 1/layer 2 condition.

According to some or all disclosed exemplary aspects, the at least one configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility (e.g. based on the layer 1 measurement);
(c) a lower layer mobility configuration comprising a lower layer mobility condition; or
(d) a lower layer mobility configuration and a conditional handover configuration, wherein optionally a further apparatus, in particular a source network node providing a source cell (e.g. a second apparatus according to the second or seventh exemplary aspect), adjusted a lower layer mobility condition to the conditional handover condition.

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

The figures show:

FIG. 1 an illustration showing an exemplary cell handover scenario;

FIG. 2 a flowchart showing an example embodiment of a method an apparatus of the first exemplary aspect is caused to perform or has means for;

FIG. 3 a flowchart showing an example embodiment of a method an apparatus of the second exemplary aspect is caused to perform or has means for;

FIG. 4 a flowchart showing an example embodiment of a method an apparatus of the third exemplary aspect is caused to perform or has means for;

FIG. 5a a flowchart showing an exemplary LLM cell handover;

FIG. 5b a flowchart showing an exemplary LLM cell handover;

FIG. 6a a flowchart showing an exemplary LLM cell handover;

FIG. 6b a flowchart showing an exemplary LLM cell handover;

FIG. 7a a flowchart showing an exemplary CHO cell handover;

FIG. 7b a flowchart showing an exemplary CHO cell handover;

FIG. 8a a table showing an exemplary timer;

FIG. 8b a table showing an exemplary timer;

FIG. 9a a block diagram showing an exemplary configuration;

FIG. 9b a block diagram showing an exemplary configuration, in particular an example of a dual configuration;

FIG. 9c a block diagram showing an exemplary configuration, in particular an example of a common configuration or an LLM configuration with a LLM condition;

FIG. 10a a flowchart showing an example embodiment of a method e.g. performed inter alia together by an apparatus of the first, second, and third exemplary aspect;

FIG. 10b a flowchart showing an example embodiment of a method e.g. performed inter alia together by an apparatus of the first, second, and third aspect;

FIG. 11a a flowchart showing an example embodiment of a method e.g. performed inter alia together by an apparatus of the first, second, and third exemplary aspect;

FIG. 11b a flowchart showing an example embodiment of a method e.g. performed inter alia together by an apparatus of the first, second, and third exemplary aspect;

FIG. 12a a flowchart showing an example embodiment of a method e.g. performed inter alia together by an apparatus of the first, second, and third exemplary aspect;

FIG. 12b a flowchart showing an example embodiment of a method e.g. performed inter alia together by an apparatus of the first, second, and third exemplary aspect;

FIG. 13a a flowchart showing an example embodiment of a method e.g. performed inter alia together by an apparatus of the first, second, and third exemplary aspect;

FIG. 13b a flowchart showing an example embodiment of a method e.g. performed inter alia together by an apparatus of the first, second, and third exemplary aspect;

FIG. 13c a flowchart showing an example embodiment of a method e.g. performed inter alia together by an apparatus of the first, second, and third exemplary aspect;

FIG. 14a a flowchart showing an example embodiment of a method e.g. performed inter alia together by an apparatus of the first, second, and third exemplary aspect;

FIG. 14b a flowchart showing an example embodiment of a method e.g. performed inter alia together by an apparatus of the first, second, and third exemplary aspect;

FIG. 14c a flowchart showing an example embodiment of a method e.g. performed inter alia together by an apparatus of the first, second, and third exemplary aspect;

FIG. 15 a schematic block diagram of an example embodiment of an apparatus according to the first, second, third, sixth, seventh and/or eighth aspect and/or an example embodiment of an apparatus configured to perform the method according to the fourth exemplary aspect.

### DETAILED DESCRIPTION OF SOME EXEMPLARY EMBODIMENTS

The following description serves to deepen the understanding and shall be understood to complement and be read together with the description as provided in the above summary section of this specification. Some aspects may have a different terminology than e.g. provided in the description above. The skilled person will nevertheless understand that those terms refer to the same subject-matter, e.g. by being more specific. For instance, a handover may be referred to as a cell switch, or cell change or a node switch (in case of the handover involves switching to another the node), a source cell may be referred to as a serving cell, and a network node may be referred to simply as a node.

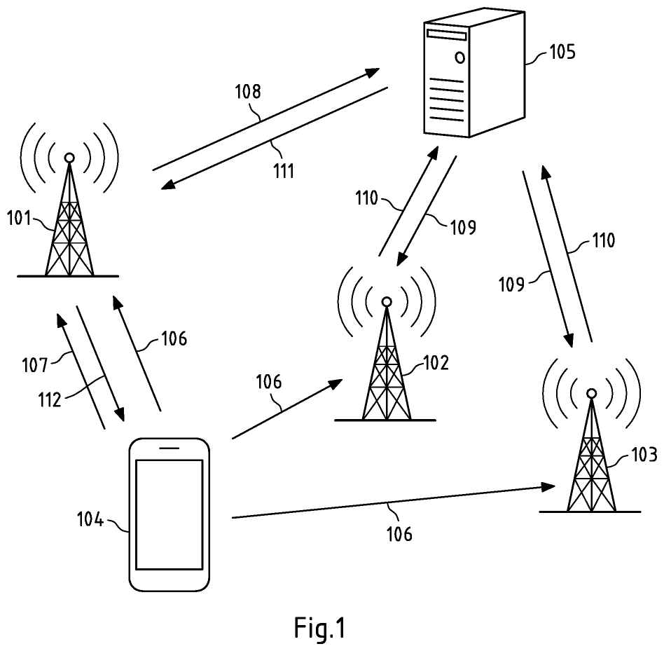

FIG. 1 shows an exemplary (cell) handover from a source cell provided by a source (network) node 101 (e.g. a second apparatus) to a target cell provided by a target node 102 from a set of candidate nodes 102, 103. A mobile entity 104 (e.g. a first apparatus) performs layer 3 and (periodic) layer 1 measurements 106 on the source cell provided by the source node 101, and candidate cells provided by candidate nodes 102, 103. The mobile entity 104 transmits 107 a report on the layer 3 and layer 1 measurements to the source node 101, which is e.g. a gNB-DU. Source node 101 may transmit 108 (e.g. forward) the report to a third apparatus 105, e.g. a server, a control backbone, or a gNB-CU. Based on the reports of the measurements, the third apparatus may transmit 109 preparation requests to the candidate nodes 102, 103 for (cell) handover, which in turn may transmit 110 an appropriate configuration. A handover condition may be determined and transmitted 111 alongside the configuration to the source node 101. In case the source node received e.g. a configuration comprising a conditional handover configuration, the source node may adjust a lower layer mobility condition (e.g. a lower layer mobility trigger condition for handover) to the received conditional handover condition (e.g. the LLM triggers cell change according to the CHO condition). The source node 101 may transmit 112 (e.g. forward) the CHO condition and configuration to the mobile entity 104. In case the source node received e.g. a configuration comprising a lower layer mobility configuration with a lower layer mobility condition, it may transmit 112 (e.g. forward) to the mobile entity 104 the lower layer mobility configuration with the lower layer mobility condition. The source node 101 may initiate cell handover to a target cell provided by a target node 102 (i.e. a cell provided by a node for which the handover condition holds or is present). In response, to receiving the configuration comprising the handover condition, a UE 104 may initiate cell handover autonomously in case the handover condition is present and e.g. the source node did not initiate the handover (e.g. through an according trigger) e.g. within a certain time interval measured by a timer.

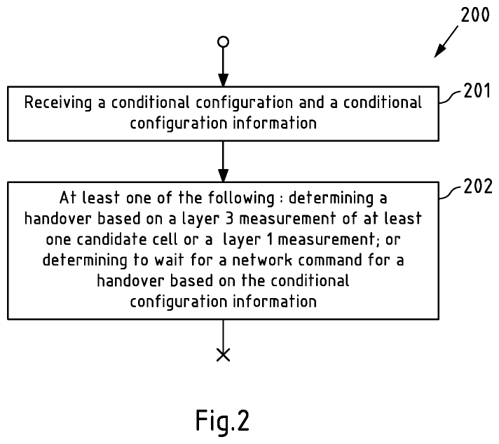

FIG. 2 is a flowchart showing an example embodiment of a method 200 according to the fourth exemplary aspect or a method a first apparatus 104 according to the first exemplary aspect is caused to perform or has means for. The first apparatus may be a mobile entity or a UE.

In a first step, a first apparatus 104 may perform:
Receiving 201 a conditional configuration and a conditional configuration information (e.g. from a source network node 101). The conditional configuration and a conditional configuration information may e.g. be comprised by at least one configuration or for instance at least one configuration may comprise the conditional configuration and the conditional configuration information. The conditional configuration may e.g. be or comprise a dual configuration, a common configuration, a lower layer mobility configuration comprising a lower layer mobility condition, or a lower layer mobility configuration and a conditional handover configuration. The conditional configuration information may e.g. be or comprise a handover condition and/or at least one or at least two timer.

In a second step, a first apparatus may perform:
At least one of the following 202: determining a handover based on a layer 3 measurement of at least one candidate cell or a layer 1 measurement; or determining to wait for a network command for a handover based on the conditional configuration information. Determining a handover may e.g. comprise evaluating (or determining) a handover condition, and based on evaluating (or determining) that the handover condition is present, initiating a handover to a target cell of at least one candidate cell, and optionally determining a handover completion condition (e.g. based on determining a handover completion condition is not present, e.g. the handover is not successful, initializing cell recovery. A network command for a handover may e.g. be or comprise a handover trigger or a stay trigger. determining to wait for a network command for a handover based on the conditional configuration information, may be e.g. determining to wait for a network command, in case the conditional configuration information comprises an instruction to wait for a network command.

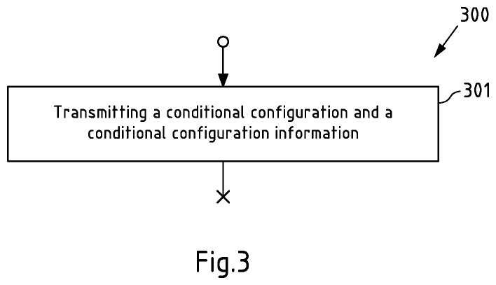

FIG. 3 is a flowchart showing an example embodiment of a method 300 according to the fourth exemplary aspect or a method a second apparatus 101 according to the second exemplary aspect is caused to perform or has means for. The second apparatus may be a gNB-DU, for example a gNB-DU providing a source cell for e.g. the first apparatus of FIG. 2.

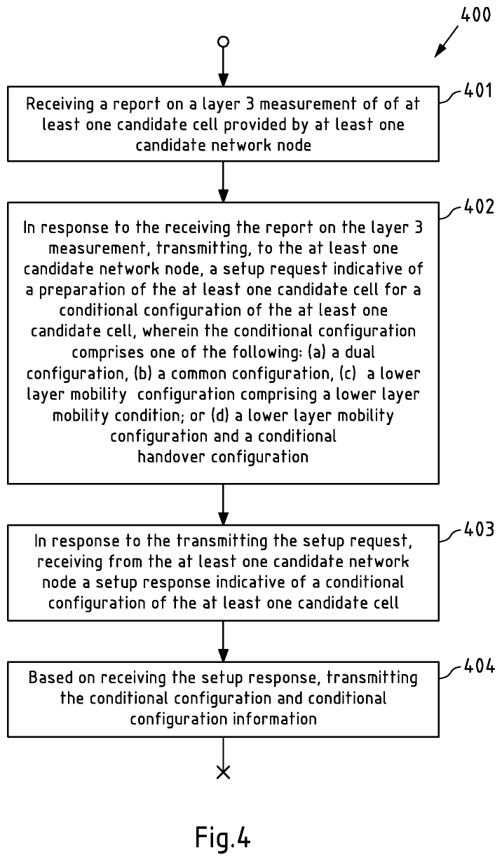

In a first step, a second apparatus 101 may perform:
Transmitting 301 a conditional configuration and a conditional configuration information FIG. 4 is a flowchart showing an example embodiment of a method 400 according to the fourth exemplary aspect or a method a third apparatus 105 according to the third exemplary aspect is caused to perform or has means for. The third apparatus may be a gNB-CU (in particular a gNB-CU-CP), for example controlling the second apparatus 101 (of FIG. 3) or gNB-DU providing a source cell for e.g. a first apparatus 104 and for example controlling a second apparatus/gNB-DU 101 providing a candidate or target cell 102, 103.

In a first step, a third apparatus 105 may perform:
Receiving 401 (e.g. from a second apparatus or gNB-DU) a report on a layer 3 measurement of at least one candidate cell provided by at least one candidate network node.

In a second step, a third apparatus 105 may perform:
In response to the receiving the report on the layer 3 measurement, transmitting 402, to the at least one candidate network node, a setup request indicative of a preparation of the at least one candidate cell for a conditional configuration of the at least one candidate cell, wherein the conditional configuration comprises one of the following: (a) a dual configuration, (b) a common configuration, (c) a lower layer mobility configuration comprising a lower layer mobility condition; or (d) a lower layer mobility configuration and a conditional handover configuration.

In a third step, a third apparatus 105 may perform:
In response to the transmitting 402, to the at least one candidate network node, a setup request, receiving 403 from the at least one candidate network node a setup response indicative of a conditional configuration of the at least one candidate cell.

In a fourth step, a third apparatus 105 may perform:
Based on receiving the setup response, transmitting 404 (e.g. to the second apparatus) the conditional configuration and conditional configuration information.

A conditional configuration information and/or a conditional configuration may e.g. comprise a handover condition. A handover condition may be a condition that is to be met/present so that handover may be initiated, it may comprise at least one of the following: a threshold value that for instance needs to be exceeded for the handover condition to be met/present, or an inequality that for instance needs to be fulfilled for the handover condition to be met/present. An inequality may e.g. be or comprise that a value comprising a measurement (result) from a candidate or target cell exceeds a value comprising a measurement (result) from the source cell, the measurement may e.g. be or be based on a layer 1 or layer 3 measurement. A handover condition may e.g. comprise a timer, e.g. the at least one timer, e.g. the timer may enable (e.g. an apparatus according to the first and/or sixth exemplary aspect) to consider a time to trigger (the handover), so that the decision for triggering the handover may be based on more than one measurement, e.g. more than one layer 1 measurement.

A CHO condition may e.g. comprise up to two CHO execution conditions per each candidate (target) cell. In case there are two CHO execution conditions provided, those are linked with conjunction relationship, so both need to be fulfilled before the handover may be initiated.

A LLM condition may e.g. have a similar structure as a CHO condition, it may e.g. comprise that a value comprising a measurement (result) from a candidate or target cell exceeds a value comprising a measurement (result) from the source cell, the measurement (result) may e.g. be or be based on a layer 1 or layer 3 measurement.

A CHO or LLM condition could e.g. be or comprise the inequality (condition):

$$Mn + Ofn + Ocn - Hys > Mp + Ofp + Ocp + Off ,$$

Wherein Mn is the measurement (result) of the neighbouring cell (e.g. candidate cell or target cell), not taking into account any offsets, Ofn is the measurement object specific offset of the reference signal of the neighbour cell, Ocn is the cell specific offset of the neighbour cell, Mp is the measurement (result) of the serving cell, not taking into account any offsets, Mp is the measurement result of the serving cell, not taking into account any offsets, Ocp is the cell specific offset of the serving cell, Hys is the hysteresis parameter for this event, Off is the offset parameter for this event (e.g. the strong neighbour detection event). A handover condition may be or comprise another inequality e.g., Mn>Mp, or other inequalities of above described values.

A measurement (result) may e.g. be or be based on a layer 1 or layer 3 measurement For a CHO condition the measurement (result) may be based on a layer 3 measurement, for a LLM condition the measurement (result) may be based on a layer 1 measurement.

Additionally, e.g. Time to trigger may be considered for this event (e.g. the handover condition to be present) if needed, in order to ensure that it is not a single measurement that impacts the decision.

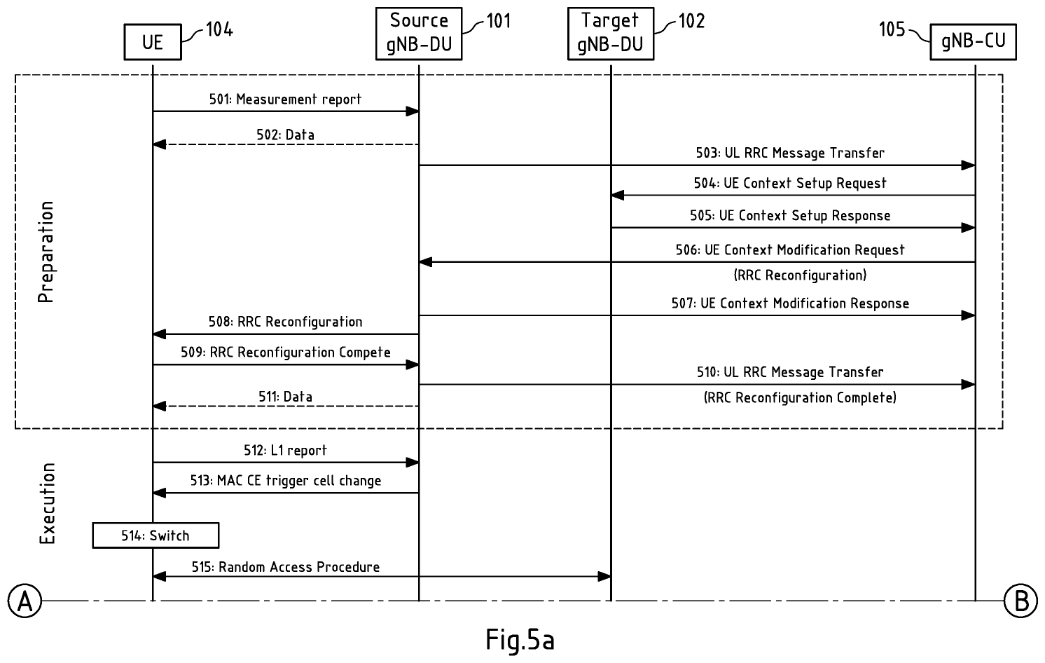

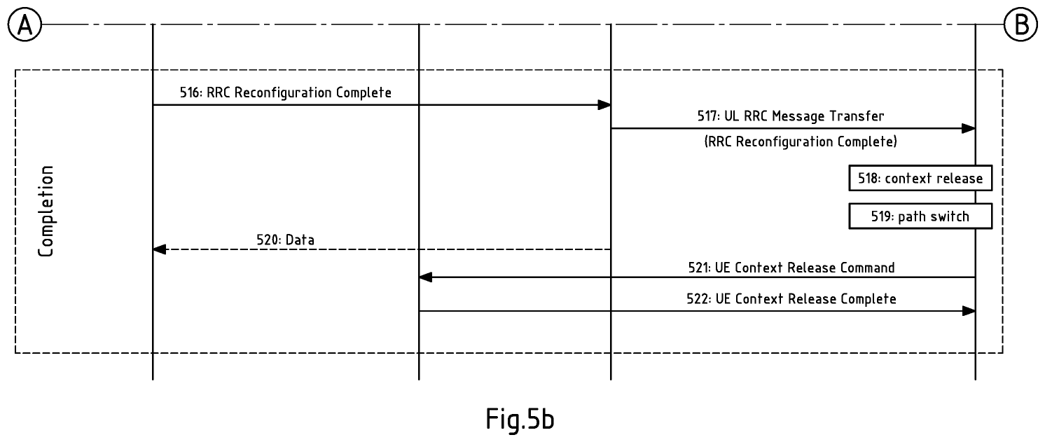

FIG. 5a and FIG. 5b show a flowchart of an exemplary LLM cell handover. Lower Layer Mobility (LLM) may refer to L1/2 centric mobility which may be based on L1 measurements and may be triggered by MAC CE (this is contrary to (RRC) L3 mobility). LLM in certain cases (i.e., intra CU handover) may enable handover with reduced interruption time. Additionally, compared to Baseline HO, it may have faster reaction to fast degradation signal. FIGS. 5a and 5b illustrate three phases of Lower Layer Mobility:
LLM Preparation: the target cells are prepared based on the UE L3 measurements
LLM Execution: the network dictates to the UE to which cell of the prepared ones it should be handed over based on the L1 reports of the UE
LLM Completion: the UE completes the HO to the target cell with context release and path switch taking place.

In case “L1 reporting(s)” or “MAC CE” loss the UE may experience RLF (cf. first two steps in the execution phase in FIG. 5a). Then the UE may perform cell reselection, but this may have increase interruption time.

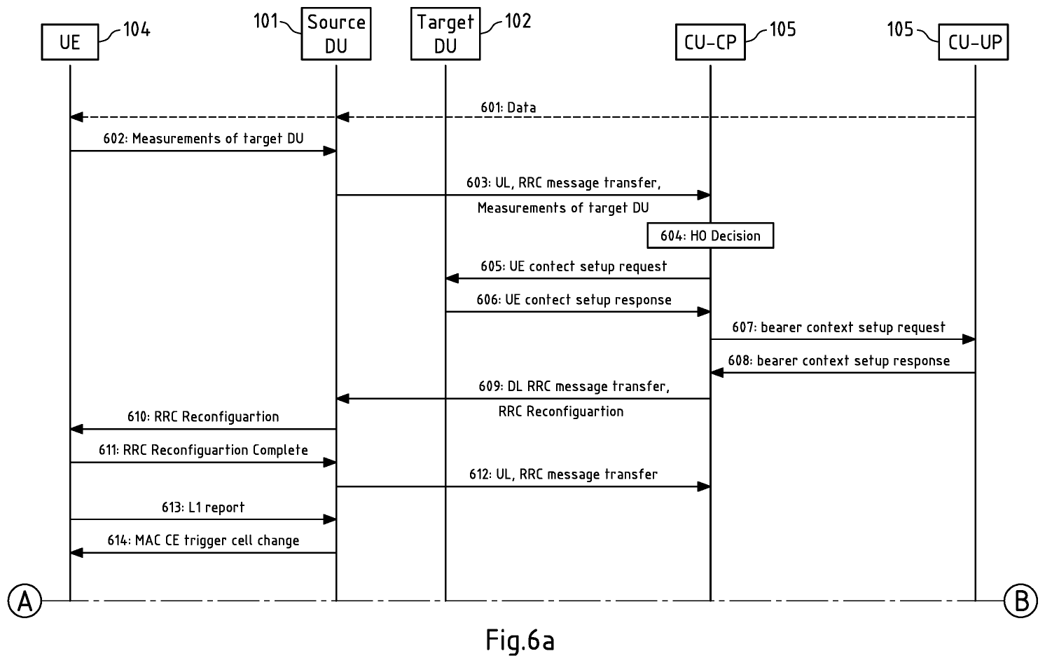

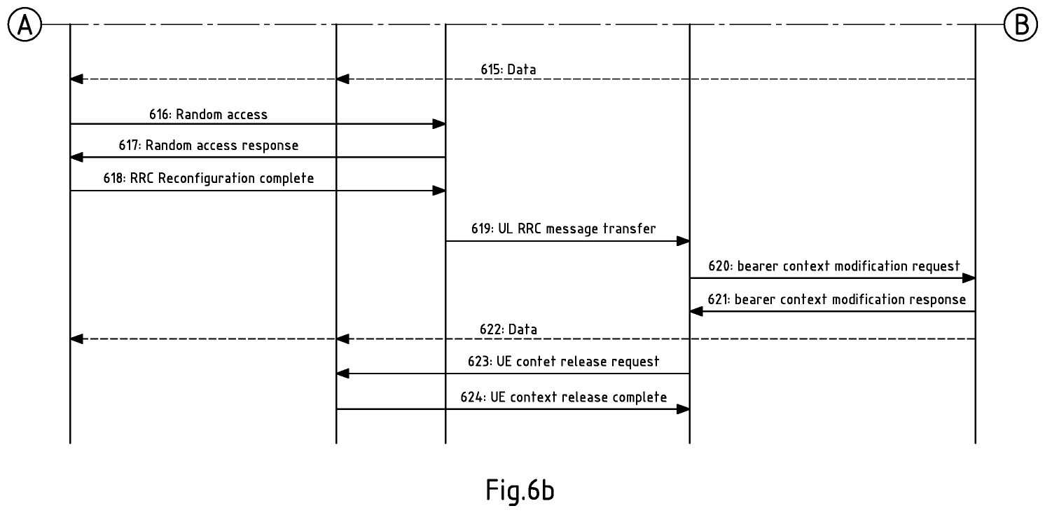

FIG. 6a and FIG. 6b show a flowchart of an exemplary LLM cell handover. Lower Layer Mobility (LLM), may be marked also as L1/2 inter-cell mobility, may enable mobility enhancement. Therein, the decision about the cell change may be based on L1 measurements and may be made in the MAC layer in the Distributed Unit (DU).

FIG. 6a and FIG. 6b show the message exchange for an inter-DU LLM scenario. In brief:
The user (UE 104) may provide the L3 measurements to the Source DU 101, which may be forwarded to the CU-CP 105 (step 602). Based on these measurements the CU-CP 105 may decide about the cell preparation (HO Decision) and may proceed in setting up the context in the target DU 102 (i.e. preparing the target cell by e.g. transmitting a preparation of the at least one candidate network for at least one configuration of the at least one candidate network node in step 605) (steps 605-606). Then CU-CP may communicate with CU-UP to perform the bearer context setup (steps 607-608).
In step 609 the CU-CP may forward the RRC Reconfiguration Request to the Source DU using a DL RRC Message Transfer and the latter may forward it to the UE (step 610). UE 104 may respond with an RRC Reconfiguration Complete which may then be forwarded to the CU-CP (steps 611-612).
The UE 104 based on its configuration may provide the periodic L1 reports to the Source DU (step 613).
Once the Source DU 101 decides that the UE should be handed over to another DU (e.g. a candidate/target DU) it may trigger the node switch, using a MAC CE (step 614). Up to this point the UE may receive data from the Serving DU 101 (i.e. a gNB-DU providing a serving/source cell).
Then the UE 104 may apply the RRC configuration for the target cell—indicated by the MAC CE and may perform Random Access (RA) to it (steps 616-617). After the RA procedure, the UE 104 may transmit an RRC Reconfiguration Complete to the Target cell, which is forwarded to the CU-CP (steps 618-619).
The CU-CP may perform bearer modification (steps 620-621) with the CU-UP, to update the bearer setup and for the latter to start forwarding the data to the Target DU 102 (and stop forwarding data to the Source DU 101). Once this is completed the UE 104 may start receiving data from the target DU 102 (step 622).
Finally, the CU-CP may release the UE context from the Source DU 101 with a UE Context Release Request (steps 623-624).

If a/the L1 report message (captured in step 613), or the MAC CE message to trigger cell change (step 614) are lost, the UE may experience RLF (determine a handover completion condition is not present) as the cell change cannot be triggered at the UE 104. Then the UE 104 may have to perform cell reselection in order to identify the proper cell to connect to.

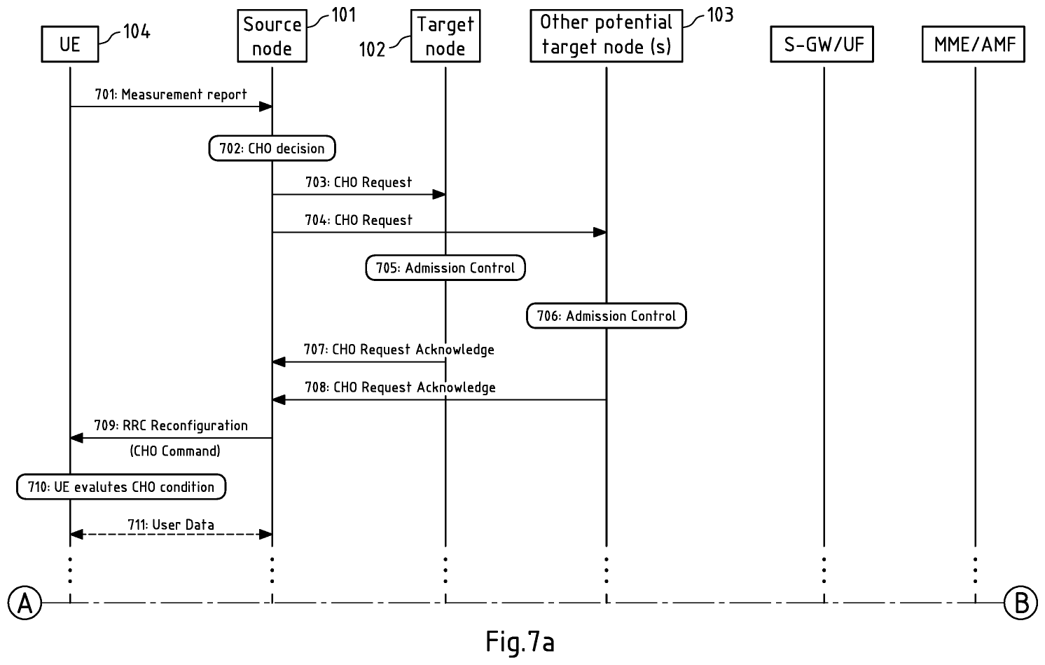

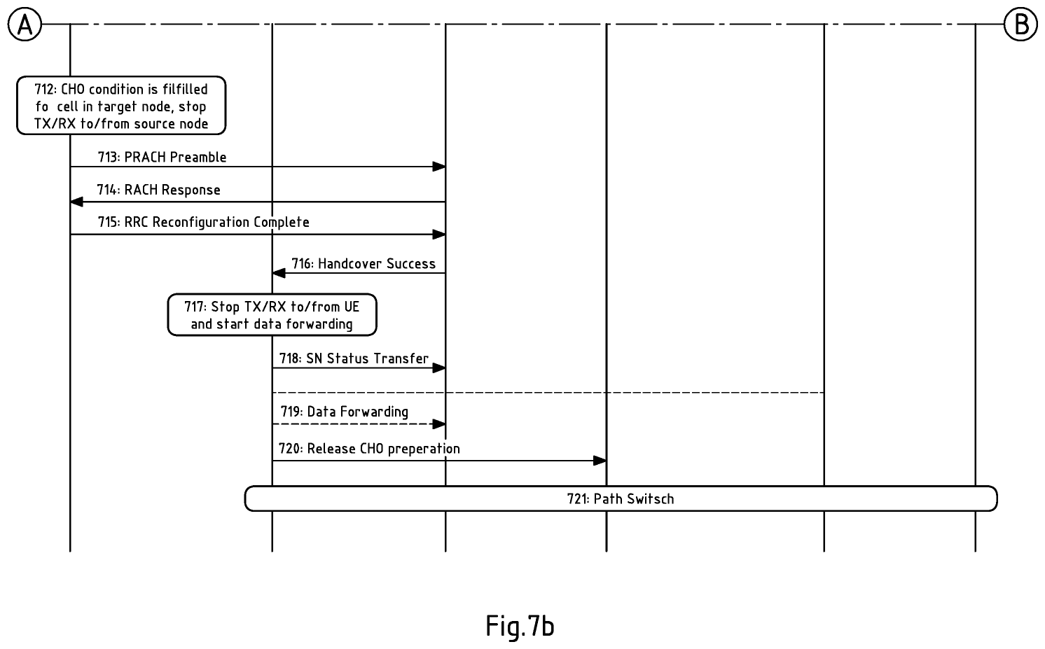

FIG. 7a and FIG. 7b show a flowchart of an exemplary CHO cell handover between a source node 101 and a target node 102.

Conditional Handover (CHO) may ensure robustness of the handover procedure. In brief, through the CHO procedure, the serving cell may prepare multiple target cells. The related conditional reconfigurations along with the CHO execution conditions may be provided beforehand to the UE 104, to ensure that the radio conditions are adequate for the UE 104 to receive the reconfigurations. Then, the UE 104 may evaluate the CHO execution condition(s) and may initiate the handover to a specific target cell once its corresponding CHO execution condition is met.

FIG. 7a and FIG. 7b present the CHO procedure in more detail. Steps 701-709 are similar to the baseline handover. At step 701, a configured event triggers the UE 104 to send a measurement report. Based on this report, the source node may prepare one or more target cells for the handover (CHO Request+CHO Request Acknowledge) and then at step 709 may send an RRC Reconfiguration (CHO command) to the UE.

The UE 104 may evaluate the CHO execution condition(s) (Step 710) and once the HO conditions holds (Step 712) the UE 104 may start timer T304 and initiate the access to the Target Cell (steps 713-715).

Once the UE 104 completes the handover execution to the target cell (e.g., the UE sent an RRC Reconfiguration Complete), the target cell may send a “Handover Success” indication (e.g. after determining that a handover completion condition is present) to the source node 101 (step 716). Then, the source node 101 may stop its TX/RX to/from the UE 104 and may start data forwarding the user plane packets to the target cell in step 719. Moreover, when the source node 101 receives a “HO Success” indication as show in step 720, it may release the CHO preparations in other (candidate or) target nodes/cell(s).

If CHO fails due to T304 expiry the UE may e.g.:
Declare Radio Link Failure (RLF) and initiate RRC Connection Re-establishment procedure, or,
Perform CHO-Recovery (if configured so by the network) provided at least more than one CHO targets are prepared (e.g. candidate cells/nodes are prepared with CHO condition). In CHO recovery, the UE 104 may first trigger cell selection procedure and if the selected cell (as per cell selection procedure) is a CHO candidate cell, the UE executes CHO to the selected candidate cell as a target cell.

LLM may have similarities with Conditional HO. In CHO the candidate/target cells are prepared based on the UE L3 measurements. UE 104 may receive the preparations in advance and may evaluate the CHO condition locally. Once the condition is fulfilled (i.e. is present) the UE 104 may start timer T304 and may proceed in execution of the HO to the target cell.

In CHO, when the CHO execution fails due to T304 expiry the UE may Declare Radio Link Failure (RLF) and initiate RRC Connection Re-establishment procedure, or, perform CHO-Recovery (if configured by the network) provided at least more than one CHO targets are prepared (cf. in this regard also steps 713 and 714). In CHO recovery, the UE may first trigger cell selection procedure and if the selected cell (as per cell selection procedure) is a CHO candidate cell, the UE 104 may execute CHO to the selected candidate/target cell.

CHO may be executed only if the associated CHO condition is met (in contrast to a baseline handover which is performed immediately upon the reception of handover command/trigger). For CHO the UE is configured with up to two execution conditions per each candidate target cell (CHO condition). In case there are two conditions provided, those are linked with conjunction relationship, so both need to be fulfilled before the handover execution may be initiated. Although the UE may be prepared with multiple candidate cells, the UE may only initiate handover to (i.e. attempt to access) just a single target cell, which may be the one that was first to meet the CHO condition. If more than a single cell meets the CHO condition, it may be up to the UE to decide which one of the candidate cells to access.

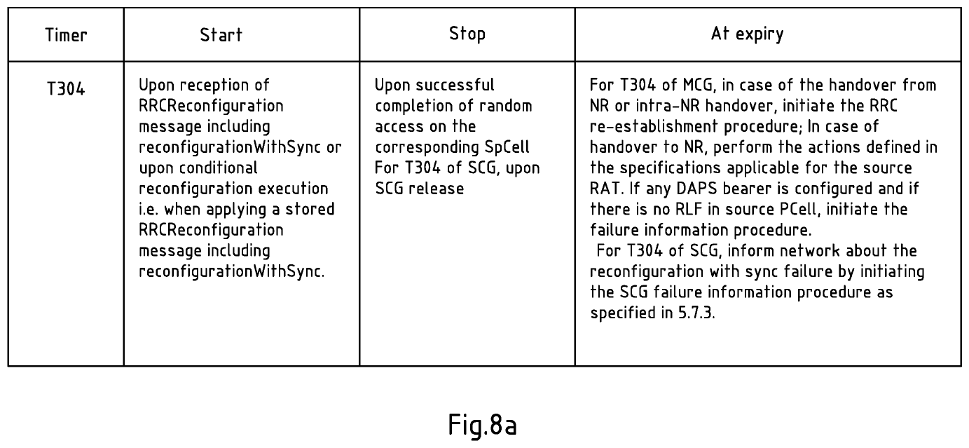

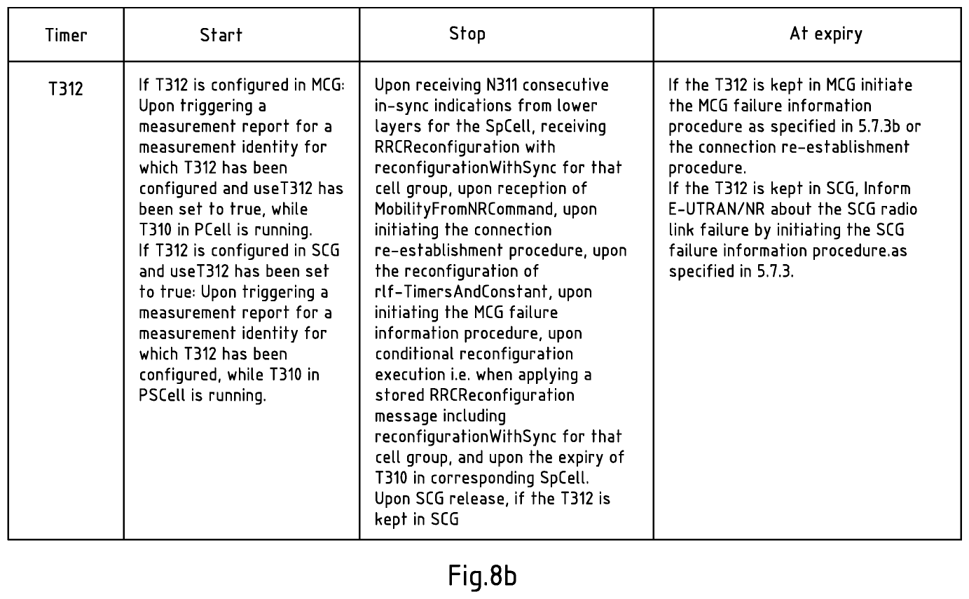

FIGS. 8a and 8b show tables comprising exemplary timers, in particular examples of a T304 or T312 timer. FIG. 8a shows details of a T304 timer. T304 time may be used to control the handover procedure. In CHO it may start once the CHO condition is fulfilled and it may stop upon successful completion of random access. FIG. 8b shows details of a T312, which may be used to supervise RLF procedure (together with T310). If T312 expires the UE may go to RRC Idle or perform RRC Re-establishment.

In LLM a UE 104 may have stored several RRC configurations of potential target cells (candidate cells). In case of RLF (in LLM), it may not be able to apply/use the provided configurations—even though this could reduce the interruption time. This would need to be enabled and specified. E.g. in case of RLF, if stored configurations are available UE can apply for recovery. But this may have to be enabled for LLM and specified.

Alternatively, the UE may be configured with both CHO and LLM and may apply one of the two, so as to have the merits of both. This however may cause a race condition between the two handovers and/or potential conflicts. The UE being configured with both CHO and LLM may end up in resource waste in the network.

As described above, in LLM a UE may be provided with configurations of potential target cells. However, in case of RLF or Handover Failure, it may not be able to apply/use the provided configurations—even though this could reduce the interruption time.

In order to enable a UE 104 that is configured with LLM to recover in an already prepared cell the UE may be configured with both CHO and LLM and apply one of the two. This may however cause a race condition between the two handovers and/or potential conflicts, which could lead to ambiguous and inconsistent behavior, and may require UE to be configured with both CHO and LLM and may end up in resource wastage overhead in the network.

A UE 104 may be configured simultaneously with both CHO and LLM independently, (without any co-ordination between them) by providing different RRC configurations for them respectively.

As stated in the previous sections, this may entail the following, but in no predictable order:
1) Enable the UE to perform LLM
2) Enable the UE to perform CHO recovery in case of an RLF/HOF.

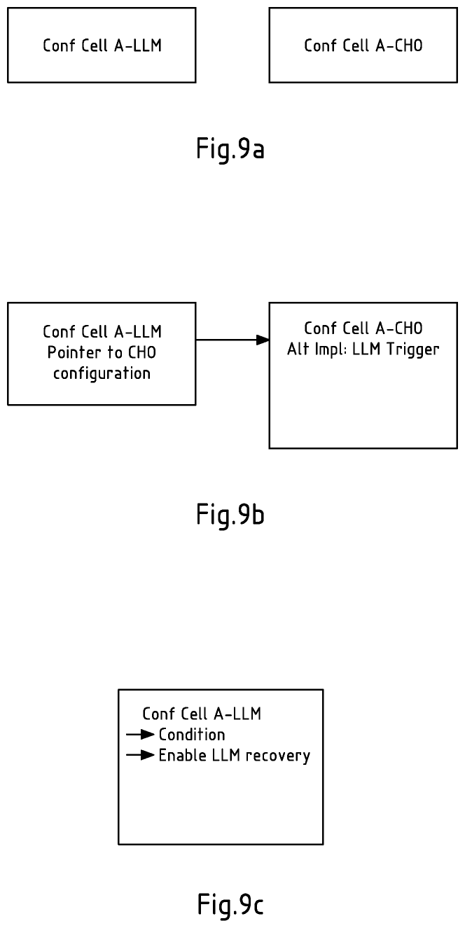

On the other hand this may:
1) Require two separate full RRC Configurations for the LLM and for the CHO (cf. FIG. 9a) in the UE side,
2) Require the UE context to be stored two times in the network side, with potential resource reservation for each configuration for the same UE at the same RAN node, which may waste resources,
3) Cause unpredictable behavior at both network and UE, e.g. if the CHO gets executed ahead of LLM.

This situation may be enhanced/improved by the following exemplary aspects/embodiments:
E.g. evaluation of a local condition (based on L1 measurements or L3 measurements) along with ongoing L1 measurements for LLM at UE 104. The UE 104 may perform HO either based on the local evaluation or based on NW response to L1-Report (or to a notification of fulfilled condition).
E.g. in case of a RLF or HOF the UE 104 may perform recovery to one of the prepared cells whenever feasible (e.g., prepared cell is configured and available to the UE 104).

In a first alternative (e.g. method), the RRC configuration of CHO is combined with that of LLM (an example of a dual configuration, cf. FIG. 9b) which may enable efficient resource reservation and interworking, whereas a further alternative is based on enhancement of the LLM RRC configuration (an example of a common configuration or LLM configuration with LLM condition). Further details of the alternatives (e.g. alternative methods) are presented below.

First exemplary alternative (e.g. method or apparatus comprising means for), a combination of RRC Reconfiguration for CHO and LLM:
1) Combine the LLM RRC configuration for a prepared target cell with a CHO RRC configuration. This means that the LLM configuration will be linked (have a pointer to a RRC Reconfiguration ID for CHO) with a CHO RRC configuration (cf. FIG. 9b). The configuration differences (IEs) between LLM and CHO may be marked explicitly in the RRC Configuration.
2) In this case the network may neither perform dual resource reservation (for LLM and CHO) nor maintain duplicates of the UE context and the UE may know that these two configurations are linked; schematically this is captured in FIG. 9b.
3) Additionally, the Serving DU 101 may be notified by the CU-CP 105 about this Dual Configuration so as to operate in a non-conflicting manner (i.e., not to have more aggressive CHO handover condition compared to LLM, not to declare internal/link failure and perform UE context release upon expiry of HARQ transmissions and maintain UE context for a possible CHO execution, etc.).
4) The CU-CP may configure the DU with appropriate LLM execution thresholds to ensure CHO execution criteria is not configured to be executed before LLM execution threshold. Alternatively, if the LLM execution thresholds are configured at DU's OAM, the CU-CP may indicate the configuration value range for LLM (over F1) to avoid CHO-LLM execution unpredictability.

Second exemplary alternative (e.g. method or apparatus comprising means for), LLM with Condition:
1) This may enhance the LLM procedure. An execution condition as fallback to DU based LLM may be appended to the LLM RRC Configuration. (as captured in FIG. 9c).
2) Once the condition is met—the UE may decide to switch to the target (cell/node) autonomously.
3) In case of detection of Radio Link Problem (RLP—initiation of timer T310) through network configured condition—the UE may decide autonomously to switch to the target cell.
4) Network needs to enable this functionality.
5) The interworking between LLM and CHO configurations to avoid conflict may be applicable here also (as in the first alternative).

Further exemplary alternative (e.g. method or apparatus comprising means for), aspects of LLM Recovery for RLF:

If the UE is configured with target cell configurations for LLM, these configurations may be used for Handover Failure and RLF recovery if the best cell selected from cell reselection is one of the prepared target cells of LLM. Depending on the prepared target configurations, CU/DU may also indicate whether given configuration is suitable for LLM recovery (at the time of configuration).

FIG. 9a shows a schematic representation of two RRC Configurations, one for LLM and one for CHO. As described, this may however entail, two configurations in the UE, which may lead to signaling waste, and/or two configurations in the network, which may lead to waste of resources.

FIG. 9b shows a schematic representation of two RRC Configurations, one for LLM and one for CHO, where the LLM Configuration has a pointer to the CHO configuration (an example of a dual configuration). E.g. the one configuration points at the other, which may allow for reduction or avoidance of signaling waste or reservation waste in the network (w.r.t. the example presented in FIG. 9).

FIG. 9c shows a schematic representation of an RRC Configuration of LLM with Condition. E.g. one configuration for both LLM (an example of a common configuration or LLM configuration with LLM condition) and in case of failures No signaling waste or reservation waste in the network. Conditional-Reconfiguration entry may also indicate that this configuration may be used for LLM switching also. A variable “Other-Trigger” may be included which can be set to “Low-layer-mobility”.

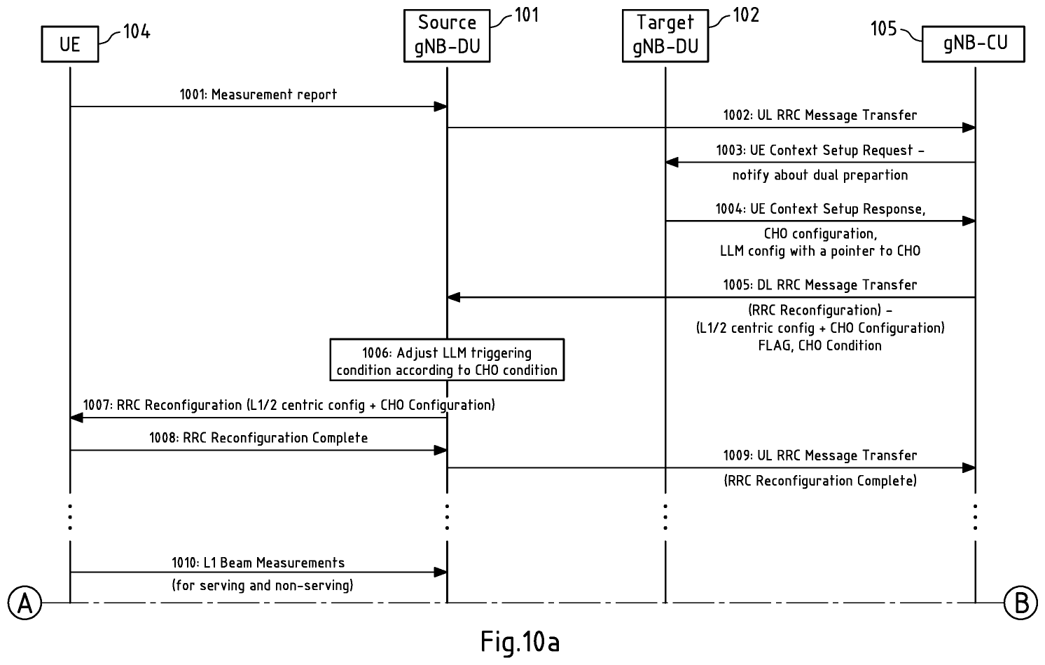

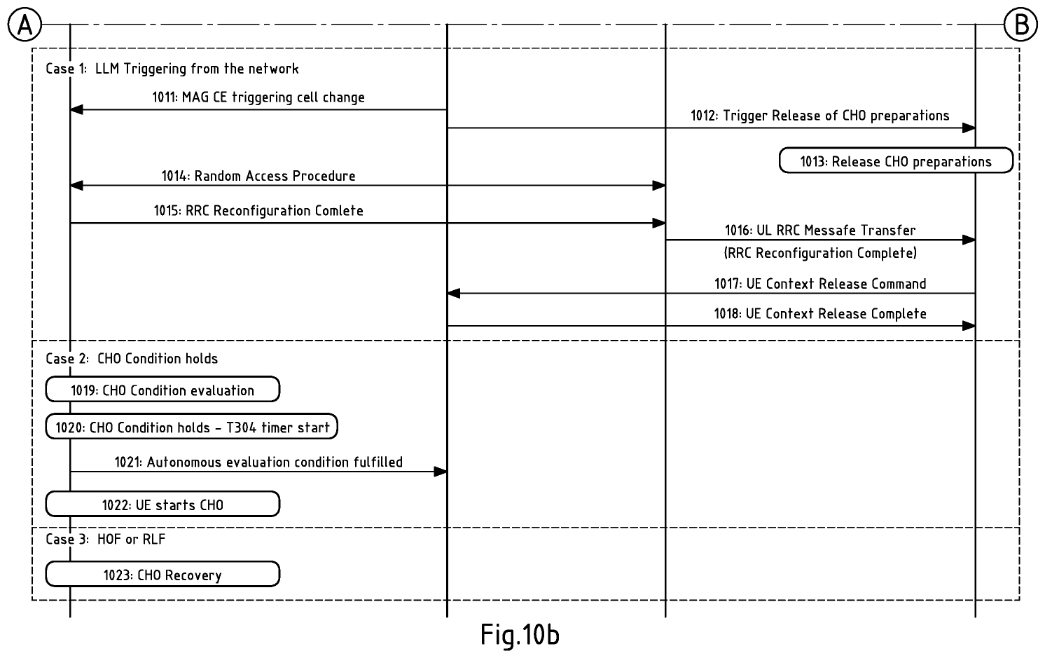

FIGS. 10a and 10b together show an example embodiment of a method (e.g. performed inter alia e.g. together by an apparatus of the first, second, and third exemplary aspect or e.g. together by an apparatus of the sixth, seventh, and eighth exemplary aspect,) in particular an example, wherein the at least one configuration comprises a dual configuration (e.g. Combination of RRC Reconfiguration for CHO and LLM).

An exemplary first apparatus 104 (e.g. a UE 104) (e.g. according to the first and/or sixth exemplary aspect) may comprise means for performing at least a part of the method of FIGS. 10a and 10b, for example the exemplary first apparatus having means for or comprising at least one processor; and at least one memory storing instructions that, when executed by the at least one processor, cause the apparatus 104 at least to perform:
Transmitting 1001, to a source network node 101, a report on a layer 3 measurement of a source cell provided by the source network node 101 and of at least one candidate cell provided by at least one candidate network node 102, 103;
Receiving 1007, from the source network node, at least one configuration for the at least one candidate cell, the at least one configuration comprising the handover condition or comprising information on the handover condition, wherein the handover condition comprises a CHO condition; the at least one configuration comprising a dual configuration, wherein the dual configuration being a lower layer mobility configuration having a pointer to a conditional handover configuration;
Transmitting 1010, to a source network node 101, (periodically) a report on a layer 1 measurement of the source cell and of the at least one candidate cell;
Receiving 1011 a handover trigger, from the source network node 101, to perform the initiating the handover;
(In response to receiving the handover trigger,) evaluating 1019 the handover condition based on the layer 3 measurement;
Based on evaluating (or determining) the handover condition is present, starting 1020 at least one timer, e.g. timer T304, and either before expiry of the at least one timer autonomously initiating 1022 the handover between the source cell and the target cell (initiating 1022 handover between the source cell and one target cell of the at least one candidate cell provided by a target network node 102 of the at least one candidate network node 102, 103 based on the handover condition), and stopping the at least one timer, or in response to expiring of the at least one timer determining that the handover completion condition is not present (e.g. Case 3: HOF or RLF) or in response to expiring of the at least one timer determining that the handover condition is not present;
Subsequent to initiating the handover, determining a handover completion condition;
Based on determining the handover completion condition is not present (e.g. detecting of radio failure (HOF or RLF)), initiating cell recovery 1023 to one of the at least one (prepared) candidate cells provided by the at least one candidate network nodes 102, 103.

An exemplary second apparatus 101 (e.g. a gNB-DU 101) (e.g. according to the second and/or seventh exemplary aspect) may comprise means for performing at least a part of the method of FIGS. 10a and 10b, for example the exemplary second apparatus having means for or comprising at least one processor; and at least one memory storing instructions that, when executed by the at least one processor, cause the apparatus 101 at least to perform:
Receiving 1001, from the first apparatus a report on a layer 3 measurement of a source cell provided by the second apparatus and of at least one candidate cell provided by at least one candidate network node;
Transmitting the report on the layer 3 measurement to a third apparatus 105 (e.g. via UL RRC message transfer message);
In response to the transmitting the report on the layer 3 measurement, receiving 1005, from the third apparatus 105 at least one configuration (e.g. RRC reconfiguration) for the at least one candidate cell comprising a handover condition (e.g. via DL RRC message transfer message), wherein the handover condition comprises a CHO condition; the at least one configuration comprising a dual configuration, wherein the dual configuration being a lower layer mobility configuration having a pointer to a conditional handover configuration;
In response to receiving, from the third apparatus 105, the at least one configuration (e.g. RRC reconfiguration):
   Determining whether a conditional handover condition is comprised by the at least one configuration;
   Based on determining that a conditional handover condition is comprised by the at least one configuration, adjusting 1006 a lower layer mobility condition to the conditional handover condition, so that the LLM condition triggers at the same time as the CHO condition.
(Prior or subsequent to the adjusting 1006), receiving, from the first apparatus a (periodic) report on a layer 1 measurement (e.g. for lower layer mobility) of the source cell and of the at least one candidate cell;
(Prior or subsequent to the adjusting 1006), transmitting 1007 the at least one configuration to the first apparatus 104;
Determining (e.g. in layer 2) whether a handover of the first apparatus 104 to a candidate network node 102, 103 is to be performed based on the report on the layer 1 measurement;
Based on determining that the handover of a first apparatus to a candidate network node is to be performed, transmitting 1011 a handover trigger to the first apparatus 104;
Transmitting 1012 a message, to the third apparatus 105, indicating to release conditional handover preparations.

An exemplary third apparatus 105 (e.g. a gNB-CU 105) (e.g. controlling the second apparatus 101 and the at least one candidate network node 102, 103) (e.g. according to the third and/or eighth exemplary aspect) may comprise means for performing at least a part of the method of FIGS. 10a and 10b, for example the exemplary third apparatus having means for or comprising at least one processor; and at least one memory storing instructions that, when executed by the at least one processor, cause the apparatus 105 at least to perform:
Receiving 1002, from the second apparatus 101, a report on a layer 3 measurement of a source cell and of at least one candidate cell provided by at least one candidate network node 102, 103;
In response to the receiving the report on the layer 3 measurement, transmitting 1003, to the at least one candidate network node 102, 103, a setup request (e.g. a UE context setup request) indicative of a preparation of the at least one candidate network node for at least one configuration of the at least one candidate network node 102, 103;
Receiving 1004 from the at least one candidate network node a setup response indicative of the at least one configuration of the at least one candidate network node 102, 103, wherein the at least one configuration comprising a dual configuration, wherein the dual configuration being a lower layer mobility configuration having a pointer to a conditional handover configuration;
Based on receiving the setup response, transmitting 1005, to the second apparatus 101, the at least one configuration for the at least one candidate cell, the at least one configuration comprising a handover condition, wherein the handover condition comprises a CHO condition;
Receiving 1012 a message, from the second apparatus 101, indicating to release conditional handover preparations;
   In response to the receiving the message indicating to release conditional handover preparations, releasing 1013 according conditional handover preparations.

The exemplary first, second, and third apparatus may e.g. perform the following method.

An exemplary method:
In step 1001 the UE may provide L3 measurements to the Source node (Source DU). These may be forwarded to the CU with UL RRC message transfer message (step 1002).
In step 1003 the CU may proceed in UE context setup request for the UE in order to prepare the Target node (Target DU) for both LLM and CHO. In this message the CU may notify the Target Node (here DU) that the preparation may be “Dual”.
   A Dual Preparation may be a preparation for LLM which has a pointer (or refers to) to a CHO configuration or vice versa, as captured in FIG. 9b.
   A Dual Preparation may not imply double resource reservation for the LLM and CHO but rather that the configuration for LLM (which comprises of mainly L1/L2 parameters) is common for the CHO (which also comprises of bearer configuration parameters). This may reduce the amount of double resource reservation.
In step 1004 the Target DU may provide the RRC Configurations for the LLM and the CHO; the configuration may be Dual; meaning that it refers to a Dual Preparation. As another embodiment, alternatively, if the CU hasn't asked the DU for the preparation to be Dual, the DU may inform the CU that it provides a dual preparation.
In step 1005 the CU may provide to the Source node (Source DU) the RRC Configuration with the preparation for the LLM and the CHO. The configuration may be dual. Additionally the CU provides to the Source DU a flag to notify that the UE is provided with LLM and CHO preparations for the same cells and also with the corresponding CHO conditions.
   The flag may enable the source DU to suspend/cancel/postpone certain procedures, e.g., context release due to loss of UE (identified by consecutives HARQ unacknowledged messages) before a timer has expired (i.e. prevents accidentally releasing the preparation of the CHO).
   The CHO condition may enable (allowing to align) the source DU to trigger cell change with respect to UE L1 measurements before CHO condition is fulfilled at UE side (i.e., not to always have the CHO condition expire instead of the LLM decision)
The Source DU may use the CHO condition to decide the LLM triggering condition (step 1006); this step may precede or follow step the forwarding of RRC Reconfiguration to the UE (see following step).
In step 1007 the Source DU may forward the RRC Reconfiguration to the UE. The UE replies with the RRC Reconfiguration Complete (step 8) which may be forwarded to the CU (step 1009).
The UE may initiate L1 beam reporting for serving and non-serving cells and at the same time evaluates the CHO condition (step 1010).
Case 1: LLM Triggering from the network:
   In case the Source node decides (based on L1 measurements) that the UE should be handed over to a new node it may send the MAC CE to trigger the cell change (step 1011).
   In step 1012 (optional message) it may inform the CU to release the CHO preparation, since it is not needed any more; these are released in step 1013. This may allow CU to remove the additional preparation (e.g. bearer configuration) as part of the CHO. Alternatively the CU may release the preparations after the procedure is concluded (step 1018).
   Steps 1014-1018 may be the same as steps 616-621 of FIG. 6b.
Case 2: CHO condition holds
   As mentioned above the UE may evaluate the CHO condition—this is captured by step 1019 but this starts upon step 1008 and may be a background operation.
   Once the condition holds the UE initiates timer T304 (as dictated by the standard operation) (step 1020)
   The UE may inform the Source node that the autonomous evaluation condition (CHO condition) has expired and it may perform CHO (step 1021).
      Source DU may indicate this to CU so the data forwarding can be initiated on time.
   Then (step 1022) the UE performs CHO as described above e.g. cf. FIGS. 7a, 7b.
Case 3: RLF or Handover Failure
   In case the T304 timer (that may be relevant for LLM HO) expires the UE may experience Handover Failure and it may perform CHO recovery. Similarly this may be applied in case of RLF (step 23),

In one alternative, the release of CHO or LLM configuration may trigger UE to consolidate the pointed RRC Reconfiguration to the non-released configuration before releasing the CHO or LLM preparation. This may remove the pointer to the released configuration. In a second alternative, the release of CHO configuration may trigger UE to remove (or ignore) the condition for the conditional configuration in case of CHO. The pointers may be kept after the release message.

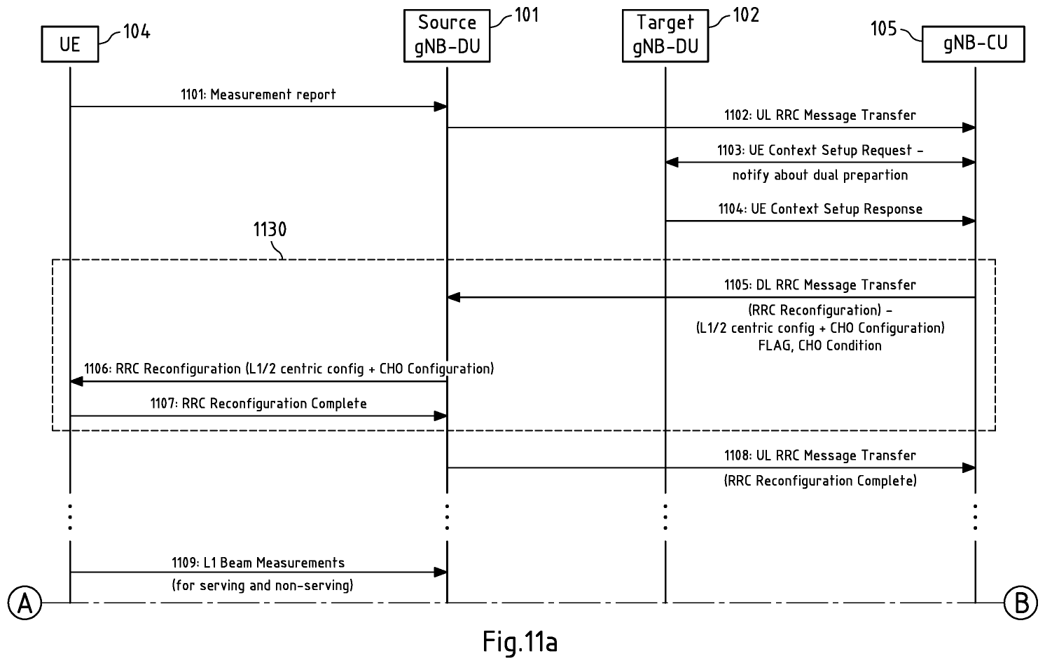

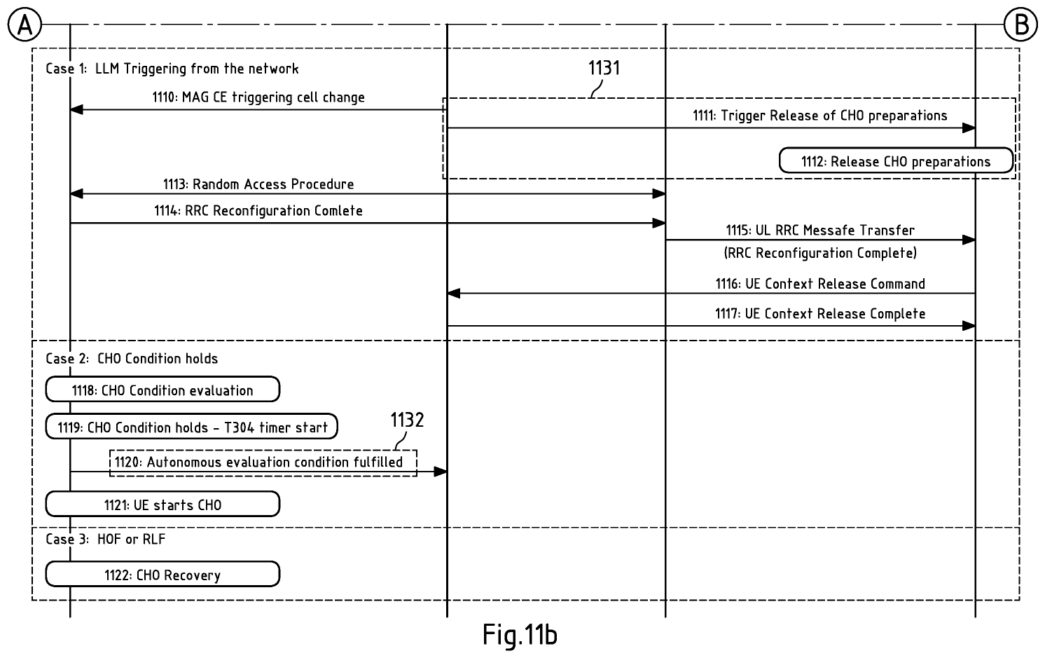

FIGS. 11a and 11b together show a further example embodiment of a method (e.g. partly similar to FIGS. 10a and 10b) (e.g. performed inter alia e.g. together by an apparatus of the first, second, and third exemplary aspect or e.g. together by an apparatus of the sixth, seventh, and eighth exemplary aspect), in particular an example, wherein the at least one configuration comprises a dual configuration (e.g. Combination of RRC Reconfiguration for CHO and LLM) (cf. FIG. 9b).

Thererin, a network may provide to the UE separate LLM and CHO configurations, which may be enhanced by provide 1 configuration with LLM and CHO (L3 Condition); LLM Execution may lead release from the CU of the prepared CHOs; LLM BYE if the TT of CHO expired and the UE may conclude to decide locally. 1130: Provide to the UE RRC Configurations for LLM+CHO. A/the Flag may enable the source DU to block certain procedures, e.g., context release due to loss of UE (identified by consecutives HARQ unacknowledged messages) before a timer has expired. 1131: LLM Execution may lead release all configurations the CU of the prepared CHOs. This may happen after receiving lower layer ACK from UE for 1110. 1132: Autonomous Evaluation may be fulfilled if TIT of CHO expired and the UE may decide to decide locally, e.g. UE may start first timer when it didnt receive any MAC CE for L1-Report on first condition (Delta earlier than actual CHO). On this timer expiry UE may send BYE ro indicate ‘auto-execution’ is going to start. This can be indication that CHO evaluation started. from this point DU may decide not to further try any LLM actions. LLM BYE may be replaced with LLM-CHO-Eva-start or LLM-UE-Exec-start. Sending a BYE at 1119 may be unreliable.

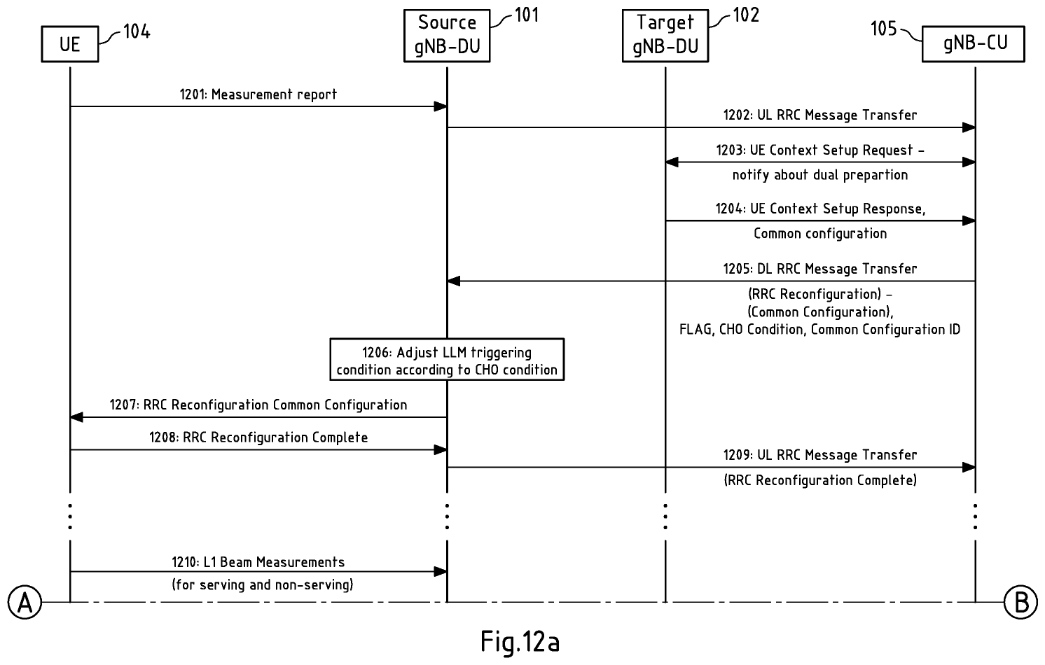

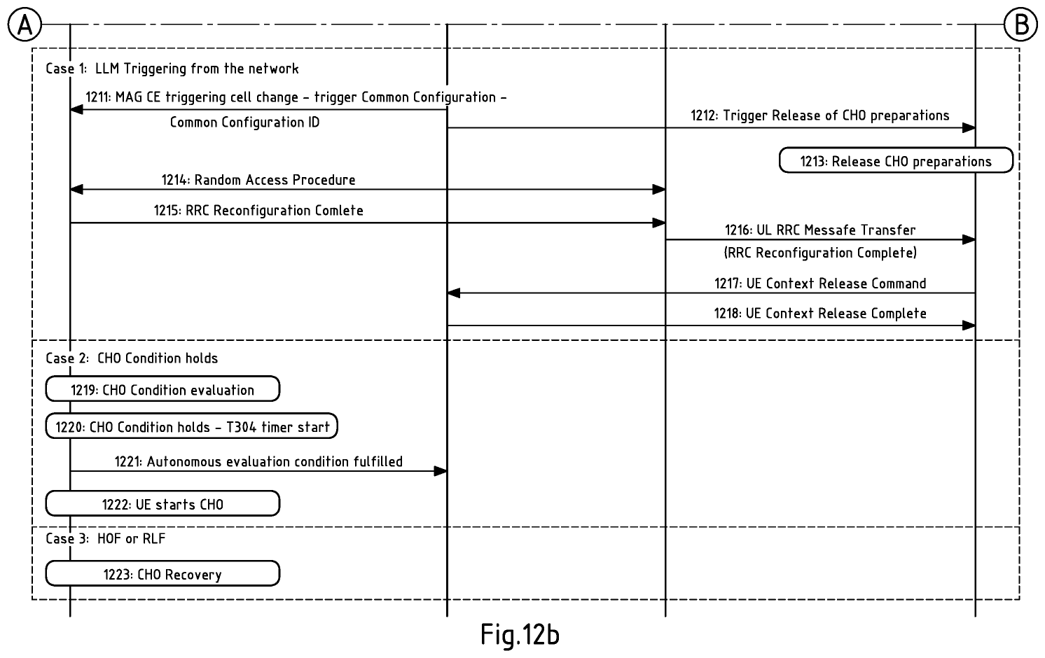

FIGS. 12a and 12b together show a further example embodiment of a method (e.g. performed inter alia e.g. together by an apparatus of the first, second, and third exemplary aspect or e.g. together by an apparatus of the sixth, seventh, and eighth exemplary aspect), in particular an example, wherein the at least one configuration comprises a common configuration.

An exemplary first apparatus 104 (e.g. a UE 104) (e.g. according to the first and/or sixth exemplary aspect) may comprise means for performing at least a part of the method of FIGS. 12a and 12b, for example the exemplary first apparatus having means for or comprising at least one processor; and at least one memory storing instructions that, when executed by the at least one processor, cause the apparatus 104 at least to perform:
Transmitting 1201, to a source network node 101, a report on a layer 3 measurement of a source cell provided by the source network node 101 and of at least one candidate cell provided by at least one candidate network node 102, 103;
Receiving 1207, from the source network node, at least one configuration for the at least one candidate cell, the at least one configuration comprising the handover condition or comprising information on the handover condition, wherein the handover condition comprises a CHO condition; the at least one configuration comprising a common configuration, wherein the common configuration is a conditional handover configuration that enables lower layer mobility;
Transmitting 1210, to a source network node 101, (periodically) a report on a layer 1 measurement of the source cell and of the at least one candidate cell;
Receiving 1211 a handover trigger, from the source network node 101, to perform the initiating the handover, the handover trigger e.g. comprising a/the identifier of the common configuration (e.g. enabling the first apparatus to trigger the common configuration) and/or a trigger of the common configuration;
(In response to receiving the handover trigger,) evaluating 1219 the handover condition based on the layer 3 measurement;
Based on evaluating the handover condition is present, starting 1220 at least one timer, e.g. timer T304, and either before expiry of the at least one timer autonomously initiating 1222 the handover between the source cell and the target cell (initiating 1222 handover between the source cell and one target cell of the at least one candidate cell provided by a target network node 102 of the at least one candidate network node 102, 103 based on the handover condition), and stopping the at least one timer, or in response to expiring of the at least one timer determining that the handover completion condition is not present (e.g. Case 3: HOF or RLF);
Subsequent to initiating the handover, determining a handover completion condition;
Based on determining the handover completion condition is not present, initiating cell recovery 1223 to one of the at least one (prepared) candidate cells provided by the at least one candidate network nodes 102, 103.

An exemplary second apparatus 101 (e.g. a gNB-DU 101) (e.g. according to the second and/or seventh exemplary aspect) may comprise means for performing at least a part of the method of FIGS. 12a and 12b, for example the exemplary second apparatus having means for or comprising at least one processor; and at least one memory storing instructions that, when executed by the at least one processor, cause the apparatus 101 at least to perform:
Receiving 1201, from the first apparatus a report on a layer 3 measurement of a source cell provided by the second apparatus and of at least one candidate cell provided by at least one candidate network node;
Transmitting 1201 the report on the layer 3 measurement to a third apparatus 105 (e.g. via UL RRC message transfer message);
In response to the transmitting the report on the layer 3 measurement, receiving 1205, from the third apparatus 105 at least one configuration (e.g. RRC reconfiguration) for the at least one candidate cell comprising a handover condition (e.g. via DL RRC message transfer message), wherein the handover condition comprises a CHO condition, the at least one configuration comprising a common configuration, wherein the common configuration is a conditional handover configuration that enables lower layer mobility;
In response to receiving, from the third apparatus 105, the at least one configuration (e.g. RRC reconfiguration):
Determining whether a conditional handover condition is comprised by the at least one configuration;
Based on determining that a conditional handover condition is comprised by the at least one configuration, adjusting 1206 a lower layer mobility condition to the conditional handover condition, so that the LLM condition triggers at the same time as the CHO condition;
(Prior or subsequent to the adjusting 1206), receiving, from the first apparatus a (periodic) report on a layer 1 measurement (e.g. for lower layer mobility) of the source cell and of the at least one candidate cell;
(Prior or subsequent to the adjusting 1206), Transmitting 1207 the at least one configuration to the first apparatus 104;
Optionally receiving, from a third apparatus 105 a flag indicating that the at least one configuration comprises a common configuration and an identifier of the common configuration;
Determining (e.g. in layer 2) whether a handover of the first apparatus 104 to a candidate network node 102, 103 is to be performed based on the report on the layer 1 measurement;
Based on determining that the handover of a first apparatus to a candidate network node is to be performed, transmitting 1211 a handover trigger to the first apparatus 104, the handover trigger e.g. comprising a/the identifier of the common configuration (e.g. enabling the first apparatus to trigger the common configuration) and/or a trigger of the common configuration;
Transmitting 1212 a message, to the third apparatus 105, indicating to release conditional handover preparations.

An exemplary third apparatus 105 (e.g. a gNB-CU 105) (e.g. controlling the second apparatus 101 and the at least one candidate network node 102, 103) (e.g. according to the third and/or eighth exemplary aspect) may comprise means for performing at least a part of the method of FIGS. 12a and 12b, for example the exemplary first apparatus having means for or comprising at least one processor; and at least one memory storing instructions that, when executed by the at least one processor, cause the apparatus 105 at least to perform:
Receiving 1202, from the second apparatus 101, a report on a layer 3 measurement of a source cell and of at least one candidate cell provided by at least one candidate network node 102, 103;
In response to the receiving the report on the layer 3 measurement, transmitting 1203, to the at least one candidate network node 102, 103, a setup request (e.g. a UE context setup request) indicative of a preparation of the at least one candidate network node for at least one configuration of the at least one candidate network node 102, 103;
Receiving 1204 from the at least one candidate network node a setup response indicative of the at least one configuration of the at least one candidate network node 102, 103, the at least one configuration comprising a common configuration, wherein the common configuration is a conditional handover configuration that enables lower layer mobility;
Based on receiving the setup response, transmitting 1205, to the second apparatus 101, the at least one configuration for the at least one candidate cell, the at least one configuration comprising a handover condition, wherein the handover condition comprises a CHO condition;
Receiving 1212 a message, from the second apparatus 101, indicating to release conditional handover preparations;
   In response to the receiving the message indicating to release conditional handover preparations, releasing 1213 according conditional handover preparations.

The exemplary first, second, and third apparatus may e.g. perform (have means for performing) the following exemplary method.

An exemplary method (may e.g. be partly similar to the exemplary method shown in FIGS. 10a/10b): A common configuration may be used both for CHO and LLM; the common configuration may be a CHO configuration that may be used also for LLM. In this case the Source DU may be provided with the Common Configuration (and the respective ID) and trigger it once the LLM condition is fulfilled. This is e.g. with reference to FIGS. 12a/12b.
In step 1201 the UE may provide L3 measurements to the Source node (Source DU). These may be forwarded to the CU with UL RRC message transfer message (step 1202).
In step 1203 the CU may proceed in UE context setup request for the UE in order to prepare the Target node (Target DU) for both LLM and CHO. In this message the CU may notify a/the Target Node (here DU) that the preparation may be “Common”.
In step 1204 the Target DU may provide the Common RRC Configuration; this may be a CHO configuration that can be used for LLM as well.
In step 1205 the CU may provide to the Source node (Source DU) the RRC Configuration with the preparation for the LLM and the CHO. The configuration may be dual. Additionally the CU may e.g. provide to the Source DU a flag to notify that this is a Common Configuration for both CHO and LLM.
   The flag may enable the source DU to suspend/cancel/postpone certain procedures, e.g., context release due to loss of UE (identified by consecutives HARQ unacknowledged messages) before a timer has expired (i.e. prevents accidentally releasing the preparation of the CHO).
   The CHO condition may enable (allowing to align) the source DU to trigger cell change with respect to UE L1 measurements before CHO condition is fulfilled at UE side (i.e., not to always have the CHO condition expire instead of the LLM decision)
   The Common Configuration ID may enable the DU to trigger this configuration.
Steps 1206-1210 are the same as steps 1006-1010 in FIGS. 10a/10b.
In step 1211, and based on the UE L1 Beam Measurements, the DU may trigger the Common Configuration using the Common Configuration ID.
Steps 1212-1223 are the same as steps 1012-1023 in FIGS. 10a/10b.

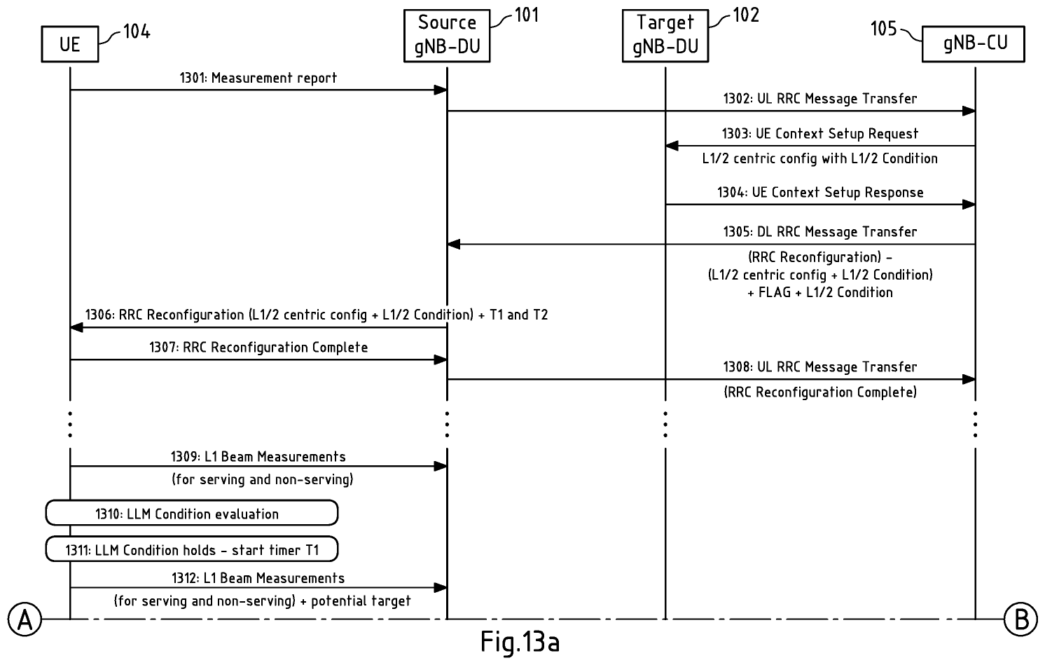

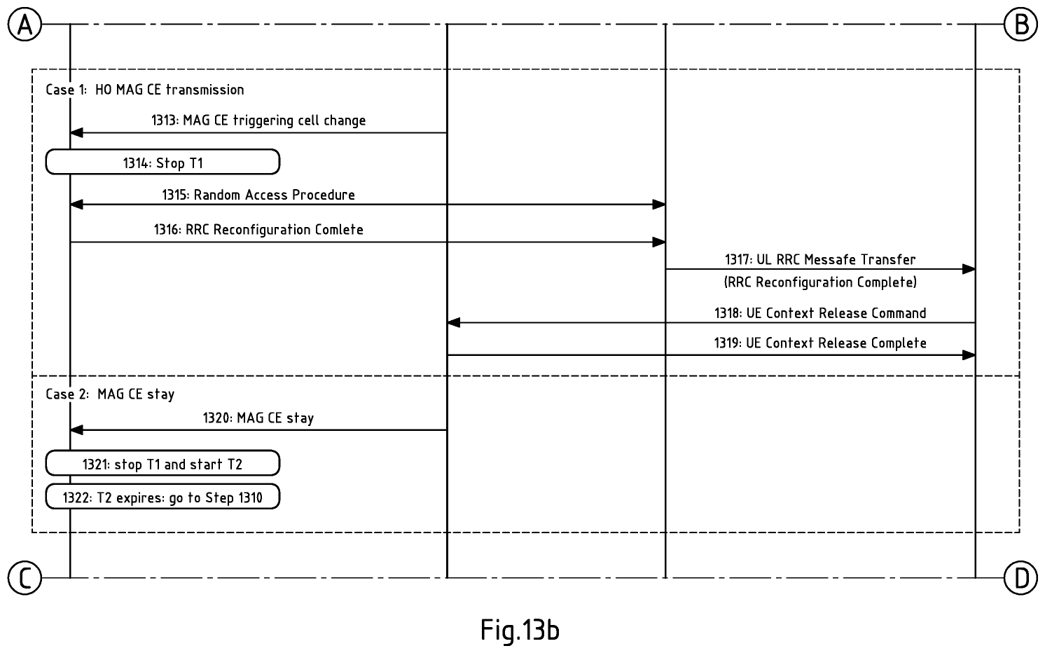

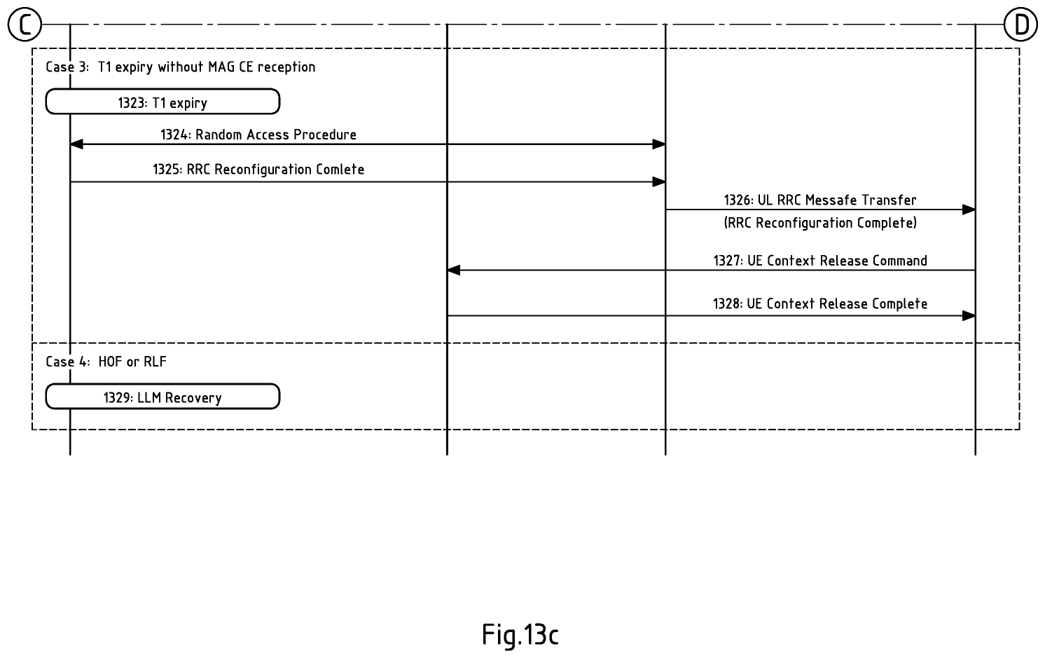

FIGS. 13a, 13b and 13c together show an example embodiment of a method (e.g. performed inter alia e.g. together by an apparatus of the first, second, and third exemplary aspect or e.g. together by an apparatus of the sixth, seventh, and eighth exemplary aspect), in particular an example, wherein the at least one configuration comprises a lower layer mobility configuration comprising a lower layer mobility condition (e.g. LLM with Condition).

An exemplary first apparatus 104 (e.g. a UE 104) (e.g. according to the first and/or sixth exemplary aspect) may comprise means for performing at least a part of the method of FIGS. 13a to 13c, for example the exemplary first apparatus having means for or comprising at least one processor; and at least one memory storing instructions that, when executed by the at least one processor, cause the apparatus 104 at least to perform:
Transmitting 1301, to a source network node 101, a report on a layer 3 measurement of a source cell provided by the source network node 101 and of at least one candidate cell provided by at least one candidate network node 102, 103;
Receiving 1306, from the source network node, at least one configuration for the at least one candidate cell, the at least one configuration comprising the handover condition or comprising information on the handover condition, wherein the handover condition comprises a lower layer mobility condition; the at least one configuration comprising a lower layer mobility configuration comprising the lower layer mobility condition;
Transmitting 1309, to a source network node 101, (periodically) a report on a layer 1 measurement of the source cell and of the at least one candidate cell;
Evaluating 1310 the handover condition based on the layer 1 measurement;
Based on evaluating the handover condition is present, starting at least one timer; and either
(i) before expiry of the at least one timer,
optionally transmitting 1312, to a source network node 101, (periodically) a report on a layer 1 measurement of the source cell and of the at least one candidate cell (e.g. including the target cell); receiving 1313 a handover trigger, from the source network node 101, to perform the initiating the handover; in response to receiving a handover trigger (e.g. on layer 2) initiating the handover between the source cell and the target cell and stopping the at least one timer;
(ii) before expiry of the at least one timer,
receiving 1320 a stay trigger, from the source network node 101, in response to receiving a stay trigger, stopping the at least one timer and starting 1422 at least one second timer, and either, before expiry of the second timer, receiving a handover trigger and stopping the at least one second timer, and initiating the handover between the source cell and one target cell; or in response to expiring 1423 of the at least one second timer without receiving a handover trigger, repeating the method starting from the evaluation of the handover condition, e.g. transmitting a further report on a further layer 1 measurement of a source cell and of the at least one candidate cell, re-evaluating the handover condition based on the further layer 1 measurement; and initiating the handover between the source cell and one target cell;
(iii) in response to expiring of the at least one timer determining that the handover completion condition is not present;
Subsequent to initiating the handover, determining a handover completion condition;
Based on determining the handover completion condition is not present, initiating cell recovery 1430 to one of the at least one (prepared) candidate cells provided by the at least one candidate network nodes 102, 103. Cell recovery may in this case be based on the at least one (prepared) LLM configuration(s).

An exemplary second apparatus 101 (e.g. a gNB-DU 101) (e.g. according to the second and/or seventh exemplary aspect) may comprise means for performing at least a part of the method of FIGS. 13a to 13c, for example the exemplary second apparatus having means for or comprising at least one processor; and at least one memory storing instructions that, when executed by the at least one processor, cause the apparatus 101 at least to perform:
Receiving 1301, from the first apparatus a report on a layer 3 measurement of a source cell provided by the second apparatus and of at least one candidate cell provided by at least one candidate network node;
Transmitting 1301 the report on the layer 3 measurement to a third apparatus 105 (e.g. via UL RRC message transfer message);
In response to the transmitting the report on the layer 3 measurement, receiving 1305, from the third apparatus 105 at least one configuration (e.g. RRC reconfiguration) for the at least one candidate cell comprising a handover condition (e.g. via DL RRC message transfer message), wherein the handover condition comprises a lower layer mobility condition; the at least one configuration comprising a lower layer mobility configuration comprising the lower layer mobility condition;
In response to receiving, from the third apparatus 105, the at least one configuration (e.g. RRC reconfiguration), transmitting 1306 the at least one configuration to the first apparatus 104;
Receiving 1309, from the first apparatus a (periodic) report on a layer 1 measurement (e.g. for lower layer mobility) of the source cell and of the at least one candidate cell;
Optionally receiving, from a third apparatus 105 a flag indicating that the at least one configuration comprises a lower layer mobility condition (e.g. the flag enabling the second apparatus to block at least one certain procedure, for example context release before a timer has expired);
   Optionally blocking the at least one certain procedure;
Determining (e.g. in layer 2) whether a handover of the first apparatus 104 to a candidate network node 102, 103 is to be performed based on the report on the layer 1 measurement;
Based on determining that the handover of a first apparatus to a candidate network node is to be performed, transmitting 1313 a handover trigger to the first apparatus 104.

An exemplary third apparatus 105 (e.g. a gNB-CU 105) (e.g. controlling the second apparatus 101 and the at least one candidate network node 102, 103) (e.g. according to the third and/or eighth exemplary aspect) may comprise means for performing at least a part of the method of FIGS. 13a to 13c, for example the exemplary third apparatus having means for or comprising at least one processor; and at least one memory storing instructions that, when executed by the at least one processor, cause the apparatus 105 at least to perform:
Receiving 1302, from the second apparatus 101, a report on a layer 3 measurement of a source cell and of at least one candidate cell provided by at least one candidate network node 102, 103;
In response to the receiving the report on the layer 3 measurement, transmitting 1303, to the at least one candidate network node 102, 103, a setup request (e.g. a UE context setup request) indicative of a preparation of the at least one candidate network node for at least one configuration of the at least one candidate network node 102, 103;
Receiving 1304 from the at least one candidate network node a setup response indicative of the at least one configuration of the at least one candidate network node 102, 103, the at least one configuration comprising a lower layer mobility configuration comprising a lower layer mobility condition
Based on receiving the setup response, transmitting 1205, to the second apparatus 101, the at least one configuration for the at least one candidate cell, the at least one configuration comprising a handover condition, wherein the handover condition comprises the lower layer mobility condition;
   Transmitting, to a second apparatus 101, a flag indicating that the at least one configuration comprises a lower layer mobility condition (e.g. the flag enabling the second apparatus to block at least one certain procedure, for example context release before a timer has expired).

The exemplary first, second, and third apparatus may e.g. perform (have means for performing) the following exemplary method.

An exemplary method (this is e.g. with reference to FIGS. 13a-13c):
In step 1301 the UE may provide L3 measurements to the Source node (Source DU). These may be forwarded to the CU with UL RRC message transfer message (step 1302).
In step 1303 the CU proceeds in UE context setup request for the UE in order to prepare the Target node (Target DU) for LLM with Condition.
   LLM with Condition may be a preparation for LLM which has a condition that can be evaluated locally by the UE, as captured in FIG. 9c.
In step 1304 the Target DU may provide the Configuration for LLM. The Target DU may provide the Condition for the LLM to the UE.
In step 1305 the CU may provide to the Source node (Source DU) the RRC Configuration for LLM with Condition. If not provided in Step 1304 the CU may add the LLM Condition. Additionally the CU provides to the Source node a flag to notify configuration is LLM with Condition and also the LLM condition.
   The flag may enable the source DU to block certain procedures, e.g., context release due to loss of UE (identified by consecutives HARQ unacknowledged messages) before a timer has expired.
   The LLM condition may enable the source DU not to apply more restrictive techniques for LLM compared to CHO (i.e., not to always have the CHO condition expire instead of the LLM decision)
In step 1306 the Source node may provide the RRC Reconfiguration to the UE; the UE may be provided with timer T1 and T2 in order to control the mobility procedure. T1 and T2 may be configured by the CU (and be inside the RRC Reconfiguration message) or by the DU.
The UE may reply with the RRC Reconfiguration Complete (step 1307) which may be forwared to the CU (step 1308).
The UE may initiate L1 beam reporting for serving and non serving cells and at the same time may evaluate the CHO condition (step 1309). After step 1309 the UE may initiate the evaluation of the LLM Condition (step 1310).
In step 1311 the condition holds and the UE may initiate timer T1.
In step 1312 the UE may provide the L1 beam report to the Source node and may inform it about the potential target.
Case 1: HO MAC CE Transmission
   upon the reception of the potential target from the UE, the network may send to the UE a MAC CE dictating a cell change (step 1313).
   Upon the reception of the MAC CE the UE stops the timer T1 (step 1314).
   Steps 1315-1319 may be the same as steps 616-621 of FIG. 6b.
Case 2: MAC CE stay—network decides to keep the UE under Source node
   The network upon the reception of the potential target from the UE it may decide to keep the UE under Source node and it sends a MAC CE (MAC CE Stay) to inform it to stop the cell change procedure (step 1320)
   The UE stops T1 and starts Timer T2 (step 1321). T2 is used for not repeating the procedure too often.
   Once T2 expires the UE goes to step 1310 (step 1322).
Case 3: T1 timer expires
   Once T1 expires (step 1323) and the UE hasn't received a MAC CE to trigger cell change or to stay in the cell, then the UE may perform HO to the target cell for which the condition has been met as described in (from) step 713 of FIG. 7b. Timer T304 may be used to supervise the procedure
Case 4: RLF or Handover Failure
In case of Handover Failure or RLF the UE may perform LLM recovery. LLM recovery may be the following process: the UE first may trigger cell selection procedure and if the selected cell (as per cell selection procedure) is LLM candidate cell, the UE executes HO to the selected target cell.

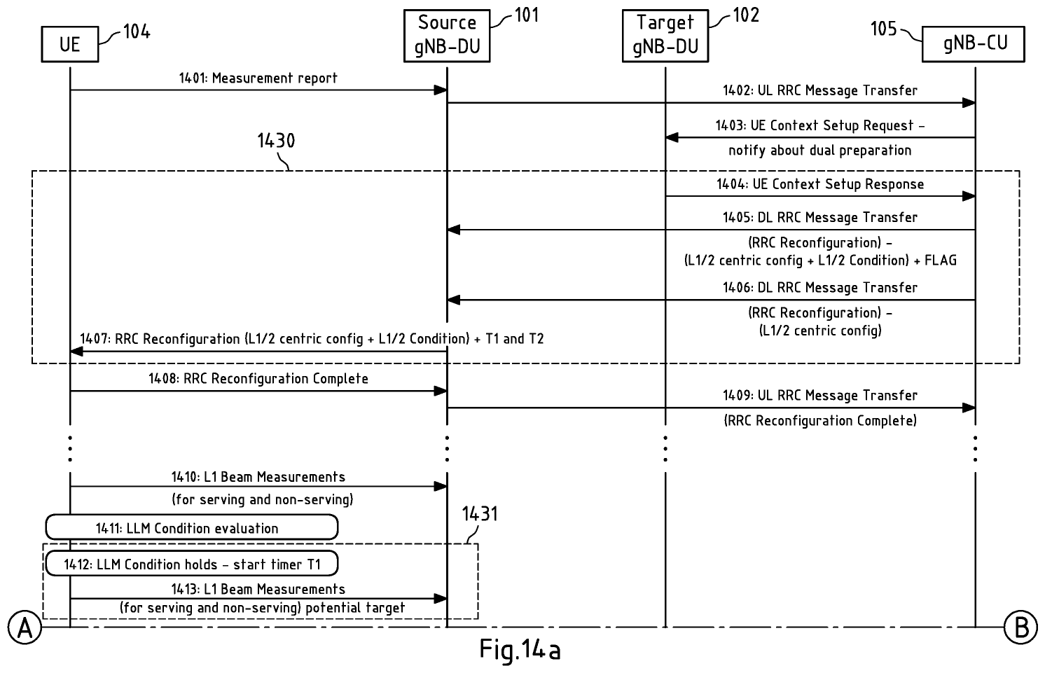

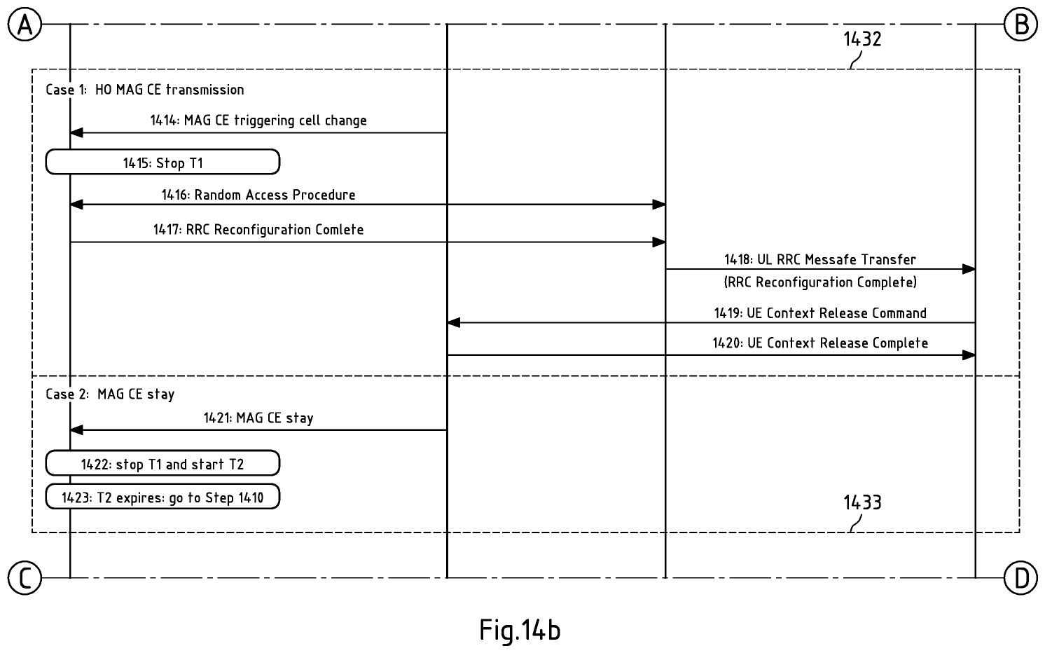

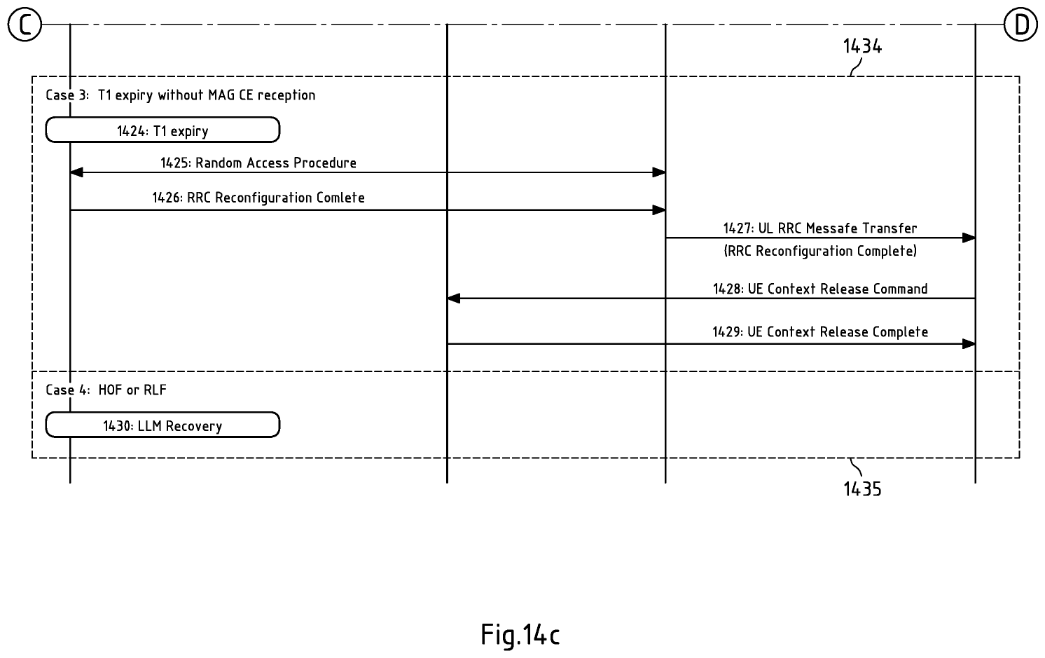

FIGS. 14a, 14b and 14c together show a further example embodiment of a method (e.g. partly similar to FIGS. 13a-13c) (e.g. performed inter alia e.g. together by an apparatus of the first, second, and third exemplary aspect or e.g. together by an apparatus of the sixth, seventh, and eighth exemplary aspect), in particular an example, wherein the at least one configuration comprises a lower layer mobility configuration comprising a lower layer mobility condition (e.g. LLM with Condition) (cf. FIG. 9c).

Therein, an LLM RRC Configuration may be enhanced with an execution condition as fallback to DU based LLM; Once the condition is met—the UE can decide to switch to the target autonomously—with the consideration of the respective timers (cf. FIGS. 14a, 14b and 14c); In case of an RLP (initiation of timer T310)—the UE may decide autonomously to switch; Network may need to enable this functionality; Optional “request to leave” and “MAC CE stay”. 1430: Provide to the UE RRC Configurations for LLM with Condition. The Flag may enable the source DU to block certain procedures, e.g., context release due to loss of UE (identified by consecutives HARQ unacknowledged messages) before a timer has expired. 1431: If the LLM Condition holds before the reception of a MAC CE triggering cell change: The UE may start timer T1: T1 may enable that the UE will wait for the network to coordinate the process; May inform the network about the potential target. 1432: The network may decide to trigger cell change—either the one indicated by the UE or a different one. 1433: The network may decide to keep the UE associated in the serving cell—the UE may start T2 before reinitiating the evaluation to ensure compliance to the network decision. This may allow for not restarting the procedure too often. Evaluation may not need be stopped, instead TIT may be extended to align the execution point later to the NW side timer. Starting evaluation later may delay the CHO execution itself. Optional Flags:

### Serving DU

RLF aspect to be included
CHO

### Target DU

Both configurations are provided to the UE
   1434: In case T1 expires the UE may perform HO since the connection with the network is not ensured. 1435: In case of RLF the UE may be enabled to perform LLM Recovery.

The network may provide the LLM configurations together with (L3/LLM) “CHO conditions”. Additionally: The UE may coordinate with the network before CHO execution if the condition is fulfilled first; The UE may apply the configurations considering timers to increase/ensure system stability; In case of RLF the UE may perform LLM recovery (similarly to CHO recovery but for LLM configurations).

Different scenarios are proposed, e.g. with dual preparation LLM/CHO with same resources, or e.g. with common LLM/CHO config, or e.g. with L1/2 config/condition and timer to enable efficient combination of LLM and CHO.

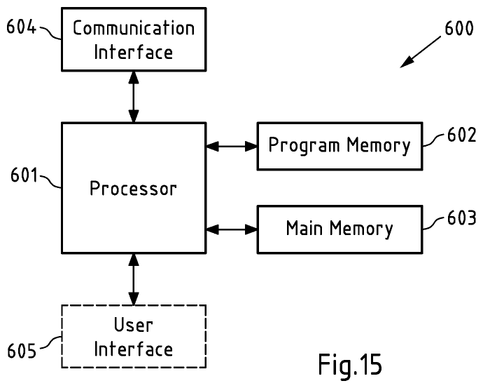

FIG. 15 is a schematic block diagram of an apparatus 600 according to an exemplary aspect, which may for instance represent one of the apparatus according to the first, second, third, sixth, seventh or eighth exemplary aspect, or e.g. apparatuses 101, 102, 103, 104, 105.

Apparatus 600 comprises a processor 601, program memory 602, working or main memory 603, data memory, communication interface(s) 604, and an optional user interface 605.

Apparatus 600 may for instance be configured to perform and/or control or comprise respective means (at least one of 601 to 605) for performing and/or controlling the method according to the fourth exemplary aspect. Apparatus 600 may as well constitute an apparatus comprising at least one processor (601) and at least one memory (602) including computer program code, the at least one memory and the computer program code configured to, with the at least one processor, cause an apparatus, e.g. apparatus 600 at least to perform and/or control the method according to some or all exemplary aspects.

Processor 601 may for instance further control the memories 602 to 603, the communication interface(s) 604, the optional user interface 605.

Processor 601 may for instance execute computer program code stored in program memory 602, which may for instance represent a computer readable storage medium comprising program code that, when executed by processor 601, causes the processor 601 to perform the method according to the fourth exemplary aspect.

Processor 601 (and also any other processor mentioned in this specification) may be a processor of any suitable type. Processor 601 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 601 may for instance be an application processor that runs an operating system.

Program memory 602 may also be included into processor 601. This memory may for instance be fixedly connected to processor 601, or be at least partially removable from processor 601, for instance in the form of a memory card or stick. Program memory 602 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 602 may also comprise an operating system for processor 601. Program memory 602 may also comprise a firmware for apparatus 600.

Apparatus 600 comprises a working memory 603, for instance in the form of a volatile memory. It may for instance be a Random Access Memory (RAM) or Dynamic RAM (DRAM), to give but a few non-limiting examples. It may for instance be used by processor 601 when executing an operating system and/or computer program.

Data memory may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory may for instance store one or more pieces of information, e.g. a measurement of a first signal, information on a first subspace, additional information.

Communication interface(s) 604 enable apparatus 600 to communicate with other entities, e.g. a first apparatus 104 to communicate with a second apparatus 101 or a second apparatus 101 to communicate with a third apparatus 105. The communication interface(s) 604 may for instance comprise a wireless interface, e.g. a cellular radio communication interface and/or a WLAN interface) and/or wire-bound interface, e.g. an IP-based interface, for instance to communicate with entities via the Internet. Communication interface(s) may enable apparatus 600 to communicate with other entities, for instance one or more entities as comprised by a mobile communication network.

User interface 605 is optional and may comprise a display for displaying information to a user and/or an input device (e.g. a keyboard, keypad, touchpad, mouse, etc.) for receiving information from a user.

Some or all of the components of the apparatus 600 may for instance be connected via a bus. Some or all of the components of the apparatus 600 may for instance be combined into one or more modules.

The disclosed exemplary aspects may allow for enable enhanced signaling, efficient resource reservation and interworking, enhanced handover procedure, e.g. faster and more efficient handover between cells, reduced interruption time in case of failure of LLM, reducing the probability of an RLF maintaining control in the network in case a UE is configured with LLM and CHO, or LLM with condition. For instance a combination of an RRC configuration of CHO with that of LLM may allow for efficient resource reservation and interworking. Further an LLM RRC configuration may be enhanced. LLM may enable reduced interruption time during handover execution. Additionally the network may be enabled to maintain control of a handover in case of fast network degradation. The disclosed exemplary aspects may further enable to achieve the same or similar robustness for LLM as for CHO.

Further, advantages of some of the disclosed exemplary aspects and embodiment may be:
LLM may enable reduced interruption time. Additionally the network may maintain control of the handover in case of fast network degradation.
Reduced interruption time in case of failure of LLM.
Maintain the control in the network in case the UE is configured with LLM and CHO, or LLM with condition.
Reduce the probability of RLF.
Achieve the same robustness as in CHO.
LLM may enable reduced interruption time during handover execution. Additionally the network may maintain control of the handover in case of fast network degradation.
Reduced interruption time in case of failure of LLM.

The following embodiments shall also be considered to be disclosed:

### Embodiment 1

A first apparatus comprising means for:
Receiving a conditional configuration and a conditional configuration information; and
At least one of the following: determining a handover based on a layer 3 measurement of at least one candidate cell or a layer 1 measurement; or determining to wait for a network command for a handover based on the conditional configuration information.

### Embodiment 2

The apparatus according to embodiment 1, further comprising means for at least one of the following:
Transmitting a report on a layer 3 measurement of at least one of the following: a source cell or of the at least one candidate cell; or
Transmitting a report on a layer 1 measurement of at least one of the following: a source cell or of the at least one candidate cell.

### Embodiment 3

The apparatus according to embodiment 1 or 2, wherein the conditional configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular a second apparatus adjusted a lower layer mobility condition to a conditional handover condition.

### Embodiment 4

The apparatus according to any one of embodiments 1 to 3, further comprising means for:
Receiving a network command for a handover, wherein the network command for the handover is a handover trigger;
In response to receiving the network command for the handover, initiating the handover between a source cell and one target cell of the at least one candidate cell, wherein the initiating the handover in particular comprises initializing a random access procedure with the target cell.

### Embodiment 5

The apparatus according to any one of embodiments 1 to 4, further comprising means for:
In response to not receiving the network command for the handover, determining the handover based on a layer 3 measurement of at least one candidate cell or a layer 1 measurement.

### Embodiment 6

The apparatus according to any one of embodiments 1 to 5, wherein the conditional configuration information comprises a handover condition or information on the handover condition,
wherein in particular the handover condition comprises at least one of the following: a conditional handover condition or a lower layer mobility condition; and
wherein the handover condition in particular comprises at least one of the following: an inequality or threshold condition; and
wherein in particular the conditional configuration information further comprises information on at least two timers.

### Embodiment 7

The apparatus according to embodiment 6, wherein the determining the handover comprises the following and the apparatus further comprising means for:
Evaluating the handover condition based on the layer 3 measurement or the layer 1 measurement;
Based on evaluating the handover condition is present, initiating the handover between the source cell and one target cell of the at least one candidate cell, wherein the initiating the handover in particular comprises initializing a random access procedure with the target cell; and optionally transmitting a notification that the handover condition is present and that the handover is initiated.

### Embodiment 8

The apparatus according to embodiment 6, wherein the determining the handover comprises the following and the apparatus further comprising means for:
Evaluating the handover condition based on the layer 3 measurement or the layer 1 measurement;
Based on evaluating the handover condition is present, starting at least one timer and either (i) before expiry of the at least one timer, initiating the handover between the source cell and the target cell and stopping the at least one timer, or (ii) in response to expiring of the at least one timer, initiating cell recovery to one of the at least one candidate cell;
and optionally transmitting a notification that the handover condition is present and that the handover is initiated.

### Embodiment 9

The apparatus according to embodiment 6, wherein the conditional configuration information further comprises information on at least two timers, the apparatus further comprising means for:
Evaluating the handover condition based on a layer 1 measurement;
Based on evaluating the handover condition is present, starting a first timer of the at least two timers; and either
   (i) before expiry of the first timer,
   Transmitting a report on a layer 1 measurement of the at least one candidate cell;
   in response to transmitting the report on the layer 1 measurement, receiving a network command for the handover, wherein the network command for the handover is a handover trigger;
   in response to receiving the handover trigger, stopping the first timer and initiating the handover between the source cell and a target cell of the at least one candidate cell;
   (ii) before expiry of the first timer,
   receiving a network command for the handover, wherein the network command for the handover is a stay trigger;
   in response to receiving the stay trigger, stopping the first timer and starting a second timer of the at least two timers, and either,
   (a) before expiry of the second timer, receiving a handover trigger and stopping the second timer, and initiating the handover between the source cell and one target cell; or
   (b) in response to expiring of the second timer without receiving a handover trigger, repeating the described steps starting from the evaluation of the handover condition based on the layer 1 measurement;
   (iii) in response to expiring of the first timer, initiating the handover between the source cell and a target cell of the at least one candidate cell.

### Embodiment 10

The apparatus according to embodiment 9, the apparatus further comprising means for:
Subsequent to initiating the handover, determining a handover completion condition;
Based on determining the handover completion condition is not present, initiating cell recovery to one of the at least one candidate cell.

### Embodiment 11

The apparatus according to any one of embodiments 1 to 10, wherein the conditional configuration or the conditional configuration information comprises an execution condition enabling the apparatus to autonomously perform initiating the handover, and optionally the apparatus further comprising means for:
Autonomously initiating the handover between the source and one target cell of the at least one candidate cell.

### Embodiment 12

The apparatus according to any one of embodiments 1 to 11, further comprising means for:
Transmitting an information indicative of a target network node based on the layer 1 measurement.

### Embodiment 13

The apparatus according to any one of embodiments 6 to 12 as far as they depend on embodiment 6, further comprising means for:
Storing the conditional configuration and the conditional configuration information;
Receiving an indication of a release of a handover condition;
Consolidate the conditional configuration and/or the conditional configuration information, in particular removing from the conditional configuration and/or the conditional configuration information the released handover condition or ignoring the released handover condition.

### Embodiment 14

A second apparatus comprising means for:
Transmitting a conditional configuration and a conditional configuration information.

### Embodiment 15

The apparatus according to embodiment 14, further comprising means for:
Receiving a report on a layer 3 measurement of a source cell provided by the second apparatus and of at least one candidate cell;
Transmitting the report on the layer 3 measurement to a third apparatus;
In response to the transmitting the report on the layer 3 measurement, receiving a conditional configuration and a conditional configuration information;
Transmitting the conditional configuration and the conditional configuration information.

### Embodiment 16

The apparatus according to embodiment 14 or 15, wherein the conditional configuration comprises one of the following:
(a) a dual configuration, wherein the dual configuration either
   (i) being a lower layer mobility configuration having a pointer to a conditional handover configuration; or
   (ii) being a conditional handover configuration having a pointer to a lower layer mobility configuration;
   wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular the second apparatus adjusted a lower layer mobility condition to the conditional handover condition.

### Embodiment 17

The apparatus according to any one of embodiments 14 to 16, wherein the conditional configuration or the conditional configuration information comprises an execution condition enabling a first apparatus to autonomously perform the initiating handover.

### Embodiment 18

The apparatus according to any one of embodiments 14 to 17, further comprising means for:
Receiving a report on a layer 1 measurement of the at least one candidate cell;
Determining whether a handover of a first apparatus to a candidate cell is to be performed based on the report on the layer 1 measurement;
Based on determining that the handover of the first apparatus to the candidate cell is to be performed, transmitting a network command for a handover, wherein the network command for the handover is a handover trigger;
Optionally transmitting a message indicating to release conditional handover preparations.

### Embodiment 19

The apparatus according to any one of embodiments 14 to 18, further comprising means for:
Receiving a report on a layer 1 measurement of the at least one candidate cell;
Determining whether a handover of a first apparatus to a candidate cell is to be performed based on the report on the layer 1 measurement;
Based on determining that the handover of the first apparatus to the candidate cell is not to be performed, transmitting a network command for a handover, wherein the network command for the handover is a stay trigger.

### Embodiment 20

The apparatus according to any one of embodiments 14 to 19, further comprising means for:
Receiving an information indicative of a target cell based on a layer 1 measurement;
Transmitting the information indicative of a target cell.

### Embodiment 21

The apparatus according to any one of embodiments 14 to 20, wherein the conditional configuration information comprises a handover condition or information on the handover condition,
wherein in particular the handover condition comprises at least one of the following: a conditional handover condition or a lower layer mobility condition; and
wherein the handover condition in particular comprises at least one of the following: an inequality or threshold condition; and
wherein in particular the conditional configuration information further comprises information on at least two timers.

### Embodiment 22

The apparatus according to any one of embodiments 14 to 21, further comprising means for:
Transmitting an indication of a release of a handover condition.

### Embodiment 23

The apparatus according to any one of embodiments 14 to 22, further comprising means for:
Receiving a flag indicating whether the conditional configuration comprises a dual configuration, a common configuration, a lower layer mobility configuration comprising a lower layer mobility condition, or a lower layer mobility configuration and a conditional handover configuration, and optionally
In response to receiving the flag, suspending, cancelling, blocking, or postponing at least one certain procedure.

### Embodiment 24

The apparatus according to any one of embodiments 15 to 23 as far as they depend on embodiment 15, further comprising means for:
In response to receiving the conditional configuration and the conditional configuration information;
Determining whether a conditional handover condition is comprised by the conditional configuration information;
Based on determining that a conditional handover condition is comprised by the conditional configuration information, adjusting a lower layer mobility condition to the conditional handover condition.

### Embodiment 25

The apparatus according to any one of embodiments 14 to 24, further comprising means for:
Receiving a notification that a handover condition is present and that the handover is initiated;
In response to receiving the notification that the handover condition is present and that the handover is initiated, transmitting a further notification that the handover condition is present and that the handover is initiated.

### Embodiment 26

The apparatus according to any one of embodiments 14 to 25, further comprising means for:
Receiving a flag indicating that the conditional configuration comprises a common configuration and an identifier of the common configuration; and optionally
Transmitting a network command for a handover, wherein the network command for the handover is a handover trigger, the handover trigger comprising the identifier of the common configuration; and optionally
Suspending, cancelling, or postponing at least one certain procedure.

### Embodiment 27

A third apparatus comprising means for:
Receiving a report on a layer 3 measurement of at least one candidate cell provided by at least one candidate network node;
In response to the receiving the report on the layer 3 measurement, transmitting, to the at least one candidate network node, a setup request indicative of a preparation of the at least one candidate cell for a conditional configuration of the at least one candidate cell, wherein the conditional configuration comprises one of the following:
   (a) a dual configuration, wherein the dual configuration either
(i) being a lower layer mobility configuration having a pointer to a conditional handover configuration; or
(ii) being a conditional handover configuration having a pointer to a lower layer mobility configuration;
wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
   (b) a common configuration, wherein the common configuration is a conditional handover configuration that enables lower layer mobility based on a layer 1 measurement;
   (c) a lower layer mobility configuration comprising a lower layer mobility condition; or
   (d) a lower layer mobility configuration and a conditional handover configuration;
In response to the transmitting the setup request, receiving from the at least one candidate network node a setup response indicative of a conditional configuration of the at least one candidate cell;
Based on receiving the setup response, transmitting the conditional configuration and conditional configuration information.

### Embodiment 28

The apparatus according to embodiment 27, wherein the conditional configuration information comprises a handover condition or information on the handover condition,
wherein in particular the handover condition comprises at least one of the following: a conditional handover condition or a lower layer mobility condition; and
wherein the handover condition in particular comprises at least one of the following: an inequality or threshold condition; and wherein in particular the conditional configuration information further comprises information on at least two timers.

### Embodiment 29

The apparatus according to embodiment 27 or 28, further comprising means for:
in response to the setup request being indicative of a preparation of the at least one candidate cell for a conditional configuration of the at least one candidate cell, wherein the conditional configuration comprises a lower layer mobility configuration and a conditional handover configuration, receiving from the at least one candidate network node an information indicative of at least one dual configuration of the at least one candidate cell.

### Embodiment 30

The apparatus according to any one of embodiments 27 to 29, further comprising means for:
Receiving an information indicative of a target cell from a second apparatus.

### Embodiment 31

The apparatus according to any one of embodiments 27 to 30, further comprising means for:
Transmitting a flag indicating whether the conditional configuration comprises a dual configuration, a common configuration, a lower layer mobility configuration comprising a lower layer mobility condition, or a lower layer mobility configuration and a conditional handover configuration.

### Embodiment 32

The apparatus according to any one of embodiments 27 to 31, further comprising means for:
Transmitting a flag indicating that the conditional configuration comprises a common configuration and an identifier of the common configuration.

### Embodiment 33

The apparatus according to any one of embodiments 27 to 32, further comprising means for:
Receiving a message indicating to release conditional handover preparations;
In response to the receiving the message indicating to release conditional handover preparations, releasing according conditional handover preparations.

### Embodiment 34

The apparatus according to any one of embodiments 27 to 33, further comprising means for:
Receiving a notification that the handover condition is present and that the handover is initiated;
In response to the receiving the notification that the handover condition is present and that the handover is initiated, indicating, to a target network node of the at least one candidate network node, to initiate data forwarding to a first apparatus.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor.

References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. The expression “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A. Further, the term “comprising” may be limited to “consisting of”, i.e. consisting of only the specified elements.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-36. (canceled)

37. A first apparatus comprising,
at least one processor; and
at least one memory storing instructions that, when executed by the at least one processor, cause the apparatus at least to perform:
Receiving a conditional configuration and a conditional configuration information; and
At least one of the following: determining a handover based on a layer 3 measurement of at least one candidate cell or a layer 1 measurement; or determining to wait for a network command for a handover based on the conditional configuration information.

38. The apparatus according to claim 37, the at least one memory further storing instructions that, when executed by the at least one processor, cause the apparatus at least to perform at least one of the following:
Transmitting a report on a layer 3 measurement of at least one of the following: a source cell or of the at least one candidate cell; or
Transmitting a report on a layer 1 measurement of at least one of the following: a source cell or of the at least one candidate cell.

39. The apparatus according to claim 37, wherein the conditional configuration comprises one of the following:
(a) a dual configuration, wherein the dual configuration either
(i) being a lower layer mobility configuration having a pointer to a conditional handover configuration; or
(ii) being a conditional handover configuration having a pointer to a lower layer mobility configuration;
wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular a second apparatus adjusted a lower layer mobility condition to a conditional handover condition.

40. The apparatus according to claim 37, the at least one memory further storing instructions that, when executed by the at least one processor, cause the apparatus at least to perform:
Receiving a network command for a handover, wherein the network command for the handover is a handover trigger;
In response to receiving the network command for the handover, initiating the handover between a source cell and one target cell of the at least one candidate cell, wherein the initiating the handover in particular comprises initializing a random access procedure with the target cell.

41. The apparatus according to claim 37,
In response to not receiving the network command for the handover, determining the handover based on a layer 3 measurement of at least one candidate cell or a layer 1 measurement.

42. The apparatus according to claim 37, wherein the conditional configuration information comprises a handover condition or information on the handover condition, wherein in particular the handover condition comprises at least one of the following: a conditional handover condition or a lower layer mobility condition; and
wherein the handover condition in particular comprises at least one of the following: an inequality or threshold condition; and
wherein in particular the conditional configuration information further comprises information on at least two timers.

43. The apparatus according to claim 38, wherein the determining the handover comprises the following and the at least one memory further storing instructions that, when executed by the at least one processor, cause the apparatus at least to perform the following:
Evaluating the handover condition based on the layer 3 measurement or the layer 1 measurement;
Based on evaluating the handover condition is present, initiating the handover between the source cell and one target cell of the at least one candidate cell, wherein the initiating the handover in particular comprises initializing a random access procedure with the target cell; and optionally transmitting a notification that the handover condition is present and that the handover is initiated.

44. The apparatus according to claim 38, wherein the determining the handover comprises the following and the at least one memory further storing instructions that, when executed by the at least one processor, cause the apparatus at least to perform the following:
Evaluating the handover condition based on the layer 3 measurement or the layer 1 measurement;
Based on evaluating the handover condition is present, starting at least one timer and either (i) before expiry of the at least one timer, initiating the handover between the source cell and the target cell and stopping the at least one timer, or (ii) in response to expiring of the at least one timer, initiating cell recovery to one of the at least one candidate cell; and optionally transmitting a notification that the handover condition is present and that the handover is initiated.

45. The apparatus according to claim 38, wherein the conditional configuration information further comprises information on at least two timers, the at least one memory further storing instructions that, when executed by the at least one processor, cause the apparatus at least to perform:
Evaluating the handover condition based on the layer 3 measurement or the layer 1 measurement;
Based on evaluating the handover condition is present, starting a first timer of the at least two timers;
Transmitting a report on a layer 1 measurement of the at least one candidate cell;
and either
(i) before expiry of the first timer,
in response to transmitting the report on the layer 1 measurement, receiving a network command for the handover, wherein the network command for the handover is a handover trigger;
in response to receiving the handover trigger, stopping the first timer and initiating the handover between the source cell and a target cell of the at least one candidate cell;
(ii) before expiry of the first timer,
in response to transmitting the report on the layer 1 measurement, receiving a network command for the handover, wherein the network command for the handover is a stay trigger;
in response to receiving the stay trigger, stopping the first timer and starting a second timer of the at least two timers, and either,
(a) before expiry of the second timer, receiving a handover trigger and stopping the second timer, and initiating the handover between the source cell and one target cell; or
(b) in response to expiring of the second timer without receiving a handover trigger, repeating the described steps starting from the evaluation of the handover condition based on the layer 1 measurement;
(iii) in response to expiring of the first timer, initiating the handover between the source cell and a target cell of the at least one candidate cell.

46. The apparatus according to claim 45, the at least one memory further storing instructions that, when executed by the at least one processor, cause the apparatus at least to perform:
Subsequent to initiating the handover, determining a handover completion condition;
Based on determining the handover completion condition is not present, initiating cell recovery to one of the at least one candidate cell.

47. The apparatus according to claim 38, wherein the conditional configuration or the conditional configuration information comprises an execution condition enabling the first apparatus to autonomously perform initiating the handover, and optionally the at least one memory further storing instructions that, when executed by the at least one processor, cause the apparatus at least to perform:
Autonomously initiating the handover between the source cell and one target cell of the at least one candidate cell.

48. The apparatus according to claim 37, the at least one memory further storing instructions that, when executed by the at least one processor, cause the apparatus at least to perform:
Transmitting an information indicative of a target network node based on the layer 1 measurement.

49. The apparatus according to claim 42, the at least one memory further storing instructions that, when executed by the at least one processor, cause the apparatus at least to perform:
Storing the conditional configuration and the conditional configuration information;
Receiving an indication of a release of a handover condition;
Consolidate the conditional configuration and/or the conditional configuration information, in particular by removing from the conditional configuration and/or the conditional configuration information the released handover condition or ignoring the released handover condition.

50. A second apparatus comprising:
at least one processor; and
at least one memory storing instructions that, when executed by the at least one processor, cause the apparatus at least to perform:
Transmitting a conditional configuration and a conditional configuration information.

51. The apparatus according to claim 50, the at least one memory further storing instructions that, when executed by the at least one processor, cause the apparatus at least to perform:
Receiving a report on a layer 3 measurement of a source cell provided by the second apparatus and of at least one candidate cell;
Transmitting the report on the layer 3 measurement to a third apparatus;
In response to the transmitting the report on the layer 3 measurement, receiving a conditional configuration and a conditional configuration information;
Transmitting the conditional configuration and the conditional configuration information.

52. The apparatus according to claim 50, wherein the conditional configuration comprises one of the following:
(a) a dual configuration, wherein the dual configuration either
(i) being a lower layer mobility configuration having a pointer to a conditional handover configuration; or
(ii) being a conditional handover configuration having a pointer to a lower layer mobility configuration;
wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition;
(d) a lower layer mobility configuration and a conditional handover configuration wherein, in particular the second apparatus adjusted a lower layer mobility condition to the conditional handover condition.

53. The apparatus according to claim 50, wherein the conditional configuration or the conditional configuration information comprises an execution condition enabling a first apparatus to autonomously perform the initiating handover.

54. The apparatus according to claim 50, the at least one memory further storing instructions that, when executed by the at least one processor, cause the apparatus at least to perform:
Receiving a report on a layer 1 measurement of the at least one candidate cell;
Determining whether a handover of a first apparatus to a candidate cell is to be performed based on the report on the layer 1 measurement;
Based on determining that the handover of the first apparatus to the candidate cell is to be performed, transmitting a network command for a handover, wherein the network command for the handover is a handover trigger;
Optionally transmitting a message indicating to release conditional handover preparations.

55. The apparatus according to claim 50, the at least one memory further storing instructions that, when executed by the at least one processor, cause the apparatus at least to perform:
Receiving a report on a layer 1 measurement of the at least one candidate cell;
Determining whether a handover of a first apparatus to a candidate cell is to be performed based on the report on the layer 1 measurement;
Based on determining that the handover of the first apparatus to the candidate cell is not to be performed, transmitting a network command for a handover, wherein the network command for the handover is a stay trigger.

56. The apparatus according to claim 50, the at least one memory further storing instructions that, when executed by the at least one processor, cause the apparatus at least to perform:
Receiving an information indicative of a target cell based on a layer 1 measurement;
Transmitting the information indicative of a target cell.

57. The apparatus according to claim 50, wherein the conditional configuration information comprises a handover condition or information on the handover condition, wherein in particular the handover condition comprises at least one of the following: a conditional handover condition or a lower layer mobility condition; and
wherein the handover condition in particular comprises at least one of the following: an inequality or threshold condition; and
wherein in particular the conditional configuration information further comprises information on at least two timers.

58. The apparatus according to claim 50, the at least one memory further storing instructions that, when executed by the at least one processor, cause the apparatus at least to perform:
Transmitting an indication of a release of a handover condition.

59. The apparatus according to claim 50, the at least one memory further storing instructions that, when executed by the at least one processor, cause the apparatus at least to perform:
Receiving a flag indicating whether the conditional configuration comprises a dual configuration, a common configuration, a lower layer mobility configuration comprising a lower layer mobility condition, or a lower layer mobility configuration and a conditional handover configuration, and optionally
In response to receiving the flag, suspending, cancelling, blocking, or postponing at least one certain procedure.

60. The apparatus according to claim 51 in so far as they depend on claim 15, the at least one memory further storing instructions that, when executed by the at least one processor, cause the apparatus at least to perform:
In response to receiving the conditional configuration and the conditional configuration information;
Determining whether a conditional handover condition is comprised by the conditional configuration information;
Based on determining that a conditional handover condition is comprised by the conditional configuration information, adjusting a lower layer mobility condition to the conditional handover condition.

61. The apparatus according to claim 50, the at least one memory further storing instructions that, when executed by the at least one processor, cause the apparatus at least to perform:
Receiving a notification that a handover condition is present and that the handover is initiated;
In response to receiving the notification that the handover condition is present and that the handover is initiated, transmitting a further notification that the handover condition is present and that the handover is initiated.

62. The apparatus according to claim 50, the at least one memory further storing instructions that, when executed by the at least one processor, cause the apparatus at least to perform:
Receiving a flag indicating that the conditional configuration comprises a common configuration and an identifier of the common configuration; and optionally
Transmitting a network command for a handover, wherein the network command for the handover is a handover trigger, the handover trigger comprising the identifier of the common configuration; and optionally
Suspending, cancelling, or postponing at least one certain procedure.

63. A third apparatus comprising:
at least one processor; and
at least one memory storing instructions that, when executed by the at least one processor, cause the apparatus at least to perform:
Receiving a report on a layer 3 measurement of at least one candidate cell provided by at least one candidate network node;
In response to the receiving the report on the layer 3 measurement, transmitting, to the at least one candidate network node, a setup request indicative of a preparation of the at least one candidate cell for a conditional configuration of the at least one candidate cell, wherein the conditional configuration comprises one of the following:
(a) a dual configuration, wherein the dual configuration either
(i) being a lower layer mobility configuration having a pointer to a conditional handover configuration; or
(ii) being a conditional handover configuration having a pointer to a lower layer mobility configuration;
wherein both in cases (i) and (ii), in particular parts of the lower layer mobility configuration and the conditional handover configuration that are common to both these configurations are only included in one of these configurations, and optionally within the dual configuration configuration differences between the lower layer mobility and the conditional handover configurations are marked explicitly;
(b) a common configuration, wherein the common configuration is a conditional handover configuration that enables lower layer mobility based on a layer 1 measurement;
(c) a lower layer mobility configuration comprising a lower layer mobility condition; or
(d) a lower layer mobility configuration and a conditional handover configuration;
In response to the transmitting the setup request, receiving from the at least one candidate network node a setup response indicative of a conditional configuration of the at least one candidate cell;
Based on receiving the setup response, transmitting the conditional configuration and conditional configuration information.
